(19) United States
(12) Patent Application Publication
(10) Pub. No.: US 2025/0215587 A1
(43) Pub. Date: Jul. 3, 2025

(54) Ultra-High Efficiency Hydrogen Hybrid Regenerative Thermodynamic System

(71) Applicant: Michael Gurin, Glenview, IL (US)

(72) Inventor: Michael Gurin, Glenview, IL (US)

(21) Appl. No.: 18/398,108

(22) Filed: Dec. 27, 2023

(51) Int. Cl. C25B 9/65; C25B 1/02; C25B 1/135; C25B 9/67; F02C 1/00

(52) U.S. Cl. CPC C25B 9/65; C25B 1/02; C25B 1/135; C25B 9/67; F02C 1/00

(57) ABSTRACT

The present invention relates to a non-combustion heat source preferably integrated with a net-positive electricity hydrogen production system and integral feedforward control system maximizing value creation by enabling superior high-radiant heat transfer and energy efficiency while minimizing carbon dioxide footprint. The feedforward control system further enhances broad system performance including determining optimal combustion emissivity and waste heat recovery operations.

### CROSS-REFERENCES

This patent application claims no priority.

### BACKGROUND OF INVENTION

Prior art includes virtually the entire field of power generation and industrial use of electricity and/or combustion processes, as well as the current transition to hydrogen as a fuel for emissions-free operations. Additional prior art includes standard nuclear power or concentrated solar systems where large-scale (typically more than 10 MW) non-combustion power is converted into predominantly electricity. Except for nuclear or solar thermal energy sources, the bulk of power generation and combustion processes are dominated by fossil fuels to provide on-demand electricity. The world is striving to transition to renewable energy including hydrogen resulting from conversion of renewable energy electricity to hydrogen to substantially reduce or eliminate carbon dioxide emissions, but most inexpensive renewable energy sources are intermittent and significantly less so when leveraging expensive battery energy storage.

Standard nuclear power has only been cost effective in very large-scale power plants (greater than 500 MW) and therefore the potential for utilization of waste heat is practically non-existent. Concentrated solar thermal is both intermittent and land intensive also making the utilization of waste heat impractical especially for energy intensive industrial processes (e.g., steel, glass, refineries, etc.). This has fundamentally limited the utilization of non-combustion electricity sources in distributed power generation (e.g., microgrid), or to replace the extensive utilization of natural gas (a.k.a. methane). Another significant limiting factor for non-combustion power plants to replace natural gas is the relatively low peak temperatures (less than 800 C, and in virtually all cases less than 700 C) is the inability to create high-radiant with high emissivity flame or flameless radiant heating. Virtually all high-temperature industrial processes require significant radiant combustion to achieve the thermal energy intensity required (otherwise the industrial equipment would be dramatically larger).

A need exists, therefore, for a non-combustion power generation system that enables industrial processes to achieve ultra-high energy efficiency and most often also with high emissivity in high intensity radiant heat transfer. And a further need exists to increase the system energy efficiency for small-scale modular nuclear energy (of any type ranging from fission, fusion to low energy nuclear reactions “LENR”).

Yet another need exists for on-site hydrogen production with its many secondary benefits with net power production without dependence on expensive electrical energy storage or grid interconnection subject to expensive peak demand charges.

Another need exists for superior heat transfer between high intensity energy sources (i.e., greater than 500 kW per square meter) for more effective phonon pathway to reduce heat exchanger size and capital cost.

A further need exists for energy efficient waste heat recovery, especially at the relatively low temperatures resulting from evaporation and/or drying operations.

Another need exists for hydrogen gas production to approximately realize cost parity to fossil fuels, especially methane.

A need also exists to reduce the physical size, capital cost, and fuel costs of power generation equipment, especially within micro- and nano-grid power generation systems.

And finally, another need exists to reduce the capital and operating costs of biofuels production, while also reducing carbon intensity of all fossil- and bio-fuels.

### FIELD OF INVENTION

The present invention generally relates especially to the field of hybrid power generation systems leveraging the unique features enabled by non-combustion thermal sources and/or on-site hydrogen production having minimized electrical inputs enabling net-positive electricity production at all times without expensive electrical energy storage or grid interconnection peak demand charges. More particularly, the present invention includes the combination of a preferred nuclear non-combustion thermal source with net-positive electricity hydrogen gas production. The further inclusion of a feedforward control system, including and specifically for dynamic thermodynamic cycle control, maximizes the value creation, minimizes the carbon dioxide footprint, maximizes energy efficiency, and minimizes capital and operating costs.

### BRIEF SUMMARY OF INVENTION

The present invention relates to a baseload non-combustion thermal “BNCT” source that increases a system energy efficiency beyond a baseload combustion thermal “BCT” source through thermal integration with a net-positive electricity “capable” hydrogen production system. The term “capable” in this context of net-positive electricity hydrogen production system is such the utilization of hydrogen to produce electricity via a high-efficiency fuel cell, internal combustion engine, or turbomachinery engine (therefore ^{˜}50% hydrogen chemical energy to electricity conversion) exceeds the electricity generated by the BNCT source.

Another embodiment of the invention, which in fact can be without a BNCT is a dual reactor electrolyzer thermally integrated into an on-site power generation solution leveraging primary and secondary benefits of on-site hydrogen production.

Yet another embodiment of the invention is combined system of BNCT source and hydrogen production system has at worst a carbon dioxide “CO2” neutral footprint and at best a carbon dioxide negative footprint, whereby any source of CO2 emissions is strongly preferred from the conversion of biogenic sources of organic matter to hydrogen, biofuels, or additional thermal sources resulting from electrochemical or combustion processes.

Another embodiment of the invention is thermal integration of the BNCT source to a thermocatalytic disassociation (i.e., pyrolysis using a catalyst to reduce reaction temperature) process of methane (preferably, or virtually any carbon and hydrogen containing molecule) where utilizing the BNCT source for endothermic energy to disassociate methane is more efficient than utilizing a BCT source.

Yet another embodiment of the invention is the thermocatalytic disassociation process leverages a catalyst enabling the temperature of disassociation to be lower than a peak operating temperature of the BNCT source, therefore eliminating any BNCT waste heat by avoiding combustion exhaust.

Another embodiment of the invention is the thermocatalytic disassociation process concurrently produces hydrogen and carbon nanotubes “CNT”.

Yet another embodiment of the invention is that both the resulting hydrogen and CNT from the disassociation process enable enhanced emissivity due to CO2 free combustion of hydrogen and/or electrically driven electric arc furnace using at least in part resulting CNT as part of the electric arc furnaces electrode.

Another embodiment of the invention is the thermal integration of the BNCT to a dual reaction electrolyzer amplifying the value of the electricity generated by the BNCT thermodynamic cycle through additional hydrogen to further enhance emissivity beyond what the BNCT is capable of without the dual reaction electrolyzer.

Yet another embodiment of the invention is the utilization of a centrifugal device imparting an at least 5G (5 times the force of gravity) for the separation of at least water (resulting from hydrogen combustion) downstream of a pressure increasing device (e.g., pump, turbo-pump, compressor, or turbo-compressor) such that the increased presence of water upstream of the pressure increasing device enhances compression being isothermal, and reduces or eliminates thermodynamic cycle fluid mass attributed to combustion products. The presence of any particulate matter will also be expelled from the thermodynamic cycle fluid due to the higher density relative to the fluid.

Another embodiment of the invention is the utilization of turbomachinery having blade compression forces to blade tensile forces greater than 2:1 (and preferably greater than 5:1, and specifically preferred greater than 10:1), whether for compression or expansion, specifically designed to handle levels of turbomachinery having blade compression forces to blade tensile forces greater than 2:1 to thermodynamic cycle fluid saturation for turbomachinery having blade compression forces to blade tensile forces lower than 1:1 of greater than 1.1:

Yet another embodiment of the invention is the electrical and thermal self-sufficiency driving the dual reactor electrolyzer by the BNCT to minimize electricity inputs from either intermittent renewable energy or grid interconnection dependencies. The electrical and thermal integration of BNCT with DRE increases the energy efficiency as compared to BCT with DRE.

Another embodiment of the invention is the thermal integration of BNCT with a mechanical vapor recompression “MVR”, preferably as a direct drive from the power generation expander, avoiding the expense of an electrical generator and additional conversion losses as known in the art, to maximize waste heat recovery greater than a BCT with MVR. The absence of the combustion exhaust substantially improves the amount of waste heat recovered upstream of the MVR. The further centrifugal separation of water maximizes system capability within drying, evaporating, or desalination thermal functions.

Yet another embodiment of the invention is utilization of concurrent production of hydrogen and carbon nanotubes to increase the energy efficiency of co-located manufacturing processes by either or both enhanced thermal conductivity, infrared energy absorption, and waste heat recovery.

Another embodiment of the invention is concurrent production of on-site electricity from on-site hydrogen with carbon nanotubes with highest methane to electricity conversion efficiency by leveraging a recuperated high-radiant hydrogen combustor serving both an integrated methane pyrolysis process and thermodynamic power generation process.

This summary is provided merely to introduce certain concepts and not to identify any key or essential features of the claimed subject matter.

### BRIEF DESCRIPTION OF DRAWINGS

FIG. 1—is a component view with supporting functional flows in a high emissivity operational mode of the BNCT.

FIG. 2—is a component view with supporting functional flows in a methane pyrolysis and dual reactor electrolyzer hydrogen production operational mode with the BNCT.

FIG. 3—is a component view with supporting functional flows in an organic liquefaction conversion with integral dual reactor electrolyzer hydrogen production operational mode with the BNCT.

FIG. 4—is a component view with supporting functional flows in an organic liquefaction conversion with integral dual reactor electrolyzer hydrogen production and mechanical vapor recompression thermal processing operational mode with the BNCT.

FIG. 5—is a component view with supporting functional flows in an organic liquefaction conversion with integral dual reactor electrolyzer hydrogen production and drying thermal processing operational mode with the BNCT.

FIG. 6—is a component view with supporting functional flows in an organic liquefaction conversion with integral dual reactor electrolyzer hydrogen production and recuperative power generation cycle leveraging oxygen from the dual reactor electrolyzer and optional catalytic pyrolysis for additional hydrogen production.

FIG. 7—is a component view of the feedforward control system of the BNCT and CP supporting the integrated hydrogen production components.

FIG. 8—is a component view of the feedforward control system of the DRE and Regenerative Radiant Processes supporting the integrated hydrogen production components.

FIG. 9—is a component view of the feedforward control system of the DRE and CP supporting the integrated hydrogen production components.

FIG. 10—is a component view of a radiant and thermally integrated methane catalytic pyrolysis process with a regenerative/recuperated thermodynamic cycle for power generation with precooling of hydrogen separator and subsequent utilization of the resulting hydrogen from the catalytic pyrolysis process directly.

FIG. 11—is a component view of a radiant and thermally integrated methane catalytic pyrolysis process with a regenerative/recuperated thermodynamic cycle for power generation without precooling of hydrogen separator and subsequent utilization of the resulting hydrogen from the catalytic pyrolysis process directly.

FIG. 12—is a component view of the feedforward control system of the catalytic pyrolysis and recuperative/regenerative power generation processes largely consuming the integrated hydrogen production components.

FIG. 13—is a component view of the feedforward control system of the lignin and

hydrogen reaction processes largely consuming the integrated hydrogen production components of the electrolyzer.

FIG. 14—is a component view of the feedforward control system of the lignin and carbon dioxide reaction processes largely consuming the integrated carbon dioxide production components of the electrolyzer.

FIG. 15—is a component view of the feedforward control system of the lignin and oxygen reaction processes largely consuming the integrated oxygen production components of the electrolyzer.

### DEFINITIONS

The term “dual reaction electrolyzer”, hereinafter also referred to as “dual reactor electrolyzer” or “DRE”, is any electrolyzer performing a chemical reaction on both the anode and cathode side of the electrolyzer with a strong preference such that normalized electricity input per kilogram “kg” of hydrogen is less than 15 kWh per kg of H2 (and particularly preferred less than 12 kWh per kg of H2, specifically preferred less than 7.7 kWh per kg of H2, and when combined with waste heat preferably less than 100 Celsius further reduces the electricity inputs to less than 5 kWh per kg of H2 and particularly preferred to less than 3 kWh per kg of H2. The preferred chemical reaction is reduction of organic molecules on the cathode side and oxidation of organic molecules on the anode side.

The term “feedforward and feedback loop control system” is the combination of feedback loop controlling components (i.e., thermal and thermodynamic cycle operation of a non-combustion power generation cycle) first using a feedforward control system for at least one hydrogen production component with integral utilization of resulting hydrogen varying at least the setpoint of feedback control system such that control parameters of the feedback control system are a function of the feedforward control system. For clarity, it is understood that the term control system is at least a feedback loop control system, and preferably a feedforward and feedback loop control system.

The term “radiant combustion”, as used herein, is combustion at conditions such that a thermally heated subject is dominated by radiant heat transfer as compared to convective heat transfer having a ratio of radiant heat transfer to convective heat transfer of at least 3:1, preferably at least 5:1, and specifically preferred at least 10:1.

The term “high emissivity”, as used herein, is emissivity greater than 0.20, and a radiant flux greater than 100 KW per square meter. A preferred high emissivity is greater than 0.50, particularly preferred greater than 0.80, and specifically preferred greater than 0.90. A specifically preferred high radiant high emissivity combustion has a radiant flux greater than 300 KW per square meter and the high emissivity greater than 0.60.

The term “high centrifugal”, as used herein, includes forces generated by rotational speeds typically greater than 100 RPM in which combustion (particularly fuel and air mixing) is impacted by the buoyancy effect. In most cases the rotational speed is more than 10,000 RPM, with the particularly preferred rotational speeds more than 100,000 RPM. The buoyant combustor when having speeds more than at least 50,000 RPM has an energy density at least 5 times more compact as compared to a stationary combustor/burner.

The term “stoichiometric excess” is an amount of at least one chemical reactant that is greater than the quantity of reactants within a balanced chemical reaction.

The term “oxidant source” is an air composition that contains oxygen ranging from 1 percent on a mass fraction basis to a highly enriched air composition up to 100 percent on a mass fraction basis, including the highly energetic monoatomic oxygen (O).

The terms “oxygen-enriched” or “oxygen-depleted” air refers to air respectively having more oxygen than stoichiometrically required or less oxygen than stoichiometrically required relative to atmospheric incoming air to achieve full combustion of fuel.

The term “fuel” is a chemical reactant that is exothermic during an oxidation reaction. It is understood that the fuel can range from traditional petrochemical fuels to Brown's Gas as well as biofuels to monoatomic hydrogen.

The term “recuperator” is a method of recovering waste heat downstream of an expander and transferring the thermal energy upstream of either a compressor, turbo-compressor, pump, or turbo-pump. Recuperator is also used interchangeably with the term regenerative in the context of combustion including regenerative burner. The term “Regenerative Radiant Processes” is also used interchangeably such that combustion results in a radiant heat flux greater than 100 KW per square meter and an emissivity greater than 0.50. A Regenerative Radiant Process preferably uses a regenerative burner and always a preheating stage of reactants upstream of combustion hence the term regenerative such that thermal energy is greater than combustion of reactants without preheating.

The term “exhaust port” is any method capable of discharging a working fluid that can include safety valve, pressure regulated valve, expansion device venting to atmosphere, etc.

The term “oxy-fuel process,” used interchangeably with “oxy-fuel combustion” or “oxyfuel” is the process of burning a fuel using pure oxygen or oxygen-enriched air as known in the art to reduce exhaust pollutants and increase overall system efficiency.

The term “separator” is any component that can partition exhaust into at least water exhaust and could be a condenser, steam recompression, water adsorber, or other separators as known in the art.

The term “infrared energy,” used interchangeably with “infrared radiation” or “infrared heat,” refers to electromagnetic radiation in the approximate range of 700-1,000 nm and/or a frequency of 430 THz-300 GHz.

The term “industrial furnace” refers to the equipment used by industrial processes, including but not limited to cement, steel, refineries, and glass processing plants, which require ultra-high radiant energy for successful and efficient operation. It is understood that the industrial furnace is more broadly thermal processes more than 1200 C (and more preferred greater than 1400 C).

The term “infrared radiation device” is any component that emits highly radiant, high emissivity energy. The preferred embodiment is a ramjet combustion engine with a transparent combustor section.

The utilization of the term “Boron-10” as used herein is the inclusion of Boron having much of the Boron in the isotope form of Boron-10 (i.e., greater than 50%), as compared to the natural ratio of Boron-10 isotope to other boron isotopes (typically Boron-11).

### DETAILED DESCRIPTION OF THE INVENTION

Here, as well as elsewhere in the specification and claims, individual numerical values and/or individual range limits can be combined to form non-disclosed ranges.

Exemplary embodiments of the present invention are provided, which reference the contained figures. Such embodiments are merely exemplary in nature. Regarding the figures, like reference numerals refer to like parts.

The transition from fossil fuels to renewable energy including hydrogen and biofuels utilizing existing known in the art technical approaches fails to provide a delivered levelized cost of energy having an approximately equivalent cost of fossil fuels. The state-of-the-art recognized delivery of hydrogen uses water electrolysis powered by intermittent renewable energy sources for an approximately normalized electricity input of 45 kWh per H2 kg. The state-of-the-art methane pyrolysis loses approximately 40% of methane's chemical energy therefore increasing the operational costs when electing to operate in a carbon dioxide neutral scenario. The utilizing of large-scale nuclear or concentrated solar is both too capital intensive and practically eliminates the ability to leverage waste heat from power generation utilizing those thermal sources. The significant expansion of intermittent renewable energy sources (e.g., solar and wind) also substantially reduces the revenue opportunities for continuous baseload operations of large-scale utility grid power plants. The relative lack of onsite electricity demand compared to waste heat opportunities for high-temperature industrial processes fails to create an adequate return on investment for waste heat recovery (especially to electricity) due to insufficient on-site electricity requirements or utility prices for electricity to the grid being too low. And the shift to electrification of everything places substantial capital costs especially for high-temperature industrial processes which then further requires ongoing electrode consumption costs (i.e., electric arc furnaces) while also continuing the failure to recovery waste heat from those same high-temperature industrial processes. Overcoming these individual shortcomings requires the inventive integration of distributed scale (i.e., behind the meter/microgrid) non-combustion thermal sources with non-water electrolysis hydrogen production methods.

The inventive BNCT provides greater than 15 kJ per mol of hydrogen “H2” for the methane disassociation reaction and greater than 5 kJ per mol of H2 produce for either organic matter liquefaction (or other pre-treatment process upstream of the DRE) or DRE. The preferred heat transfer of BNCT to methane disassociation reaction, also referred to as methane pyrolysis or “MP” is greater than 30 kJ per mol of H2 and particularly preferred greater than 37.4 kJ per mol of H2 meeting all the endothermic requirements for MP to H2. The preferred MP catalyst, as known in the art, enables MP to take place below the critical threshold of 800 degrees Celsius “C” and particularly preferred below the critical threshold of 700 C and specifically preferred below 650 C. All these temperatures do not enable BNCT to provide radiant heat transfer into co-located industrial furnace processes. Utilization of BNCT reduces by greater than 10% and preferably by greater than 15% the amount of methane required to obtain otherwise the endothermic MP energy, and within the inventive integration for high emissivity the otherwise waste heat recovery from heated hydrogen is not available. Though MP to hydrogen has a chemical energy penalty of approximately 40% the benefits of virtually no CO2 emissions and the production of CNTs shifts the benefit to cost ratio greater than 1:1. Most industrial furnace applications specifically benefit from CNTs in terms of enhanced structural properties of the resulting materials being produced in the industrial furnace, and therefore the onsite production of hydrogen and CNTs eliminate the significant logistics costs otherwise required for the importing of hydrogen and CNTs from off-site locations. Importantly, the BNCT further enables an increase of at least 5% (and preferably at least 10%, and specifically preferred at least 20%) greater waste heat recovery from the industrial furnace due to the use of BNCT as compared to BCT.

A standalone BNCT in an on-site (notably industrial process, and especially for high-temperature or radiant processes) fails to achieve cost economies and sufficient synergies with on-site processes if the primary output of the BNCT is only electricity, as electrification of everything remains. A power generation capability resulting from chemical reactions (e.g., fuel combustion or fuel cell reactions) fails to enable the often-vast waste heat opportunities available. Direct electricity to hydrogen via water electrolysis has excessive conversion losses as using a co-located BNCT to produce electricity to then produce hydrogen electrochemically for non-electric continued operations of high-temperature or radiant processes. This is the fundamental driver for the inventive combination of BNCT with non-water electrolysis hydrogen production that further uniquely leverages waste heat recovery for additional on-site hydrogen production. Electricity for the purpose of hydrogen production only makes sense through the utilization of a DRE having a net electricity consumption of less than 20 kWh per H2 kg (and preferentially less than 10 kWh per H2 kg, and particularly preferred less than 7.7 kWh per H2 kg) that has a further reduction of electricity inputs by leveraging otherwise wasted waste heat recovery for thermal source input into the DRE for operational temperatures less than 150 C (and preferentially less than 100 C, and particularly preferred less than 70 C). Effective utilization of waste heat from the co-located industrial processes is not realized if the on-site power generation device is dependent on combustion of a fuel having its own waste heat generation (which all things equal would be easier to capture compared to the industrial process waste heat).

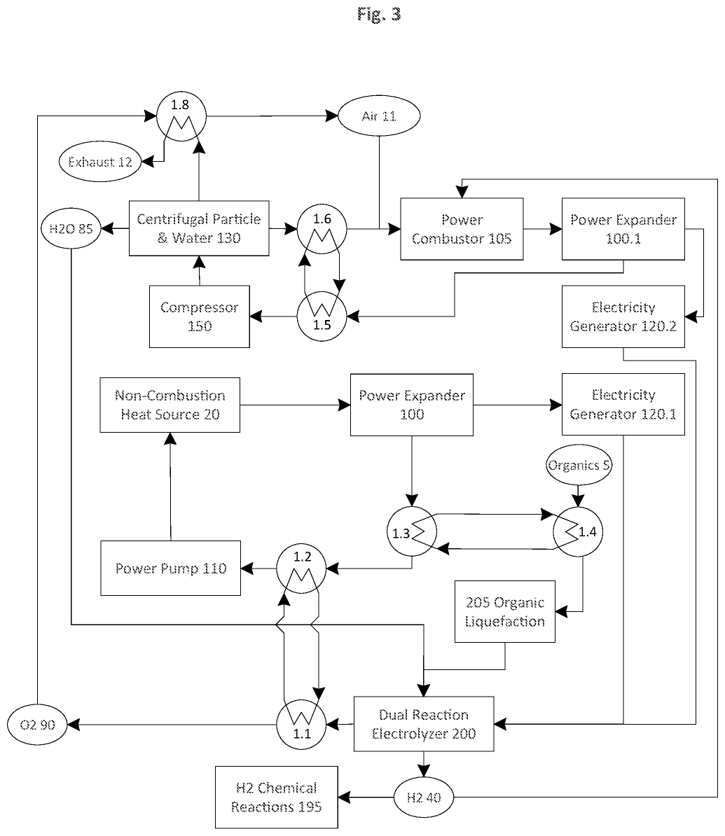

As detailed in FIG. 3, the further inclusion of organic matter thermal pretreatment both leverages the industrial process waste heat while concurrently becoming input to the DRE for additional hydrogen production. Importantly, the DRE is operated at a voltage that enables concurrent oxygen production which is particularly important for high-temperature or radiant industrial processes. The integration of the DRE with the BNCT provides for an additional baseload electric load further enabling the inventive system to maximize the value creation, as compared to selling otherwise excess electricity for suppressed pricing to the utility grid. The on-site presence of organic matter further enables the combined biofuel (preferred in a biocrude non-upgraded form) with air enriched hydrogen to shift the carbon to hydrogen to oxygen ratio into a range more consistent with traditional fossil fuels. The utilization of biocrude, which is oxygen rich in comparison to methane or other fossil fuels), is a superior carbon dioxide neutral (or negative) fuel that can be atomized and then combusted in a hydrogen enriched air therefore achieving many of the benefits of oxyfuel combustion with less demand for oxygen production. In fact, the combination of methane pyrolysis or DRE resulting in hydrogen for combustion air enrichment and biocrude (or other biomass such as lignin) for a top-cycle combustion power generation cycle enables low-cost fuel substitution especially for marine bunker or diesel fossil fuel replacement. In the inventive combination with a recuperated thermodynamic cycle the recuperator effectively homogenizes the biocrude and hydrogen into an approximately equivalent carbon to hydrogen to oxygen ratio syngas upstream of the thermodynamic cycle's combustor and then expander, therefore the substitution from fossil fuel to biofuel minimizes any changes to the critical (and expensive) turbomachinery expander section (i.e., the “hot” section). The increase in hydrogen ratio enables an increase in water vapor (and then as it passes through the expansion part of the cycle) towards condensation of the water vapor into water, which increases energy efficiency due to a higher level of isothermal compression and isothermal expansion. Then the now heated hot water uniquely can contribute to the BNCT source, as compared to the inability of a combustion BCT (i.e., non-combustion) source to leverage that lower temperature waste heat since it would not significantly enough about a combustion source exhaust temperature.

The world's stated desire to an electrification of everything transition places a significant demand for high-temperature electrodes within high-temperature industrial applications. Traditionally these electrodes utilize graphite (or synthetic forms of carbon) therefore demanding operators of high-temperature industrial processes to acquire at significant expense and supply chain logistics offsite manufactured carbon electrodes. The inventive system enables self-sufficiency not only in terms of enhanced energy efficiency but additionally the availability of the superior carbon nanotube electrodes manufactured from the methane pyrolysis CNT production. CNTs have superior technical specifications than graphite therefore enabling enhanced emissivity in electrically driven electric arc furnaces using at least in part the resulting CNTs as part of the electric arc furnace electrodes.

As noted before, an important aspect of the inventive system is the thermal integration of the BNCT to a dual reaction electrolyzer further amplifying the value of the electricity generated by the BNCT thermodynamic cycle through yet additional hydrogen to enhance emissivity yet further beyond what the BNCT is capable of without the dual reaction electrolyzer. A purely economic reason for high-temperature industrial processes to not transform high enthalpy with high temperature heat sources into high exergy power sources is the significant mismatch of waste heat generated as compared to the onsite electrical demands. Selling excess electricity to the utility grid is at insufficient prices to enable the host company realizing their financial return on investment (and return on asset) criteria. Therefore, the inventive system creating a new demand for on-site electricity that reduces the industrial host-site operating costs, carbon dioxide emissions (and any tangible and intangible costs associated), and importantly reducing capital costs otherwise required for electrification of the industrial process assets.

Another feature of using the inventive BNCT system as compared to a combustion “bottom” cycle thermal source is the effective utilization of low-temperature differential incremental thermal energy (where if it was combustion low-grade waste heat would likely be at a lower temperature than the combustion exhaust). Utilizing this low-grade waste heat, especially when combined with a larger portion of the “top” cycle power generation or high-emissivity combustion of hydrogen enriched (or approximately pure) yields a higher proportion of the combustion exhaust being water vapor. A relatively small amount of compression will create saturated vapor therefore when “filtered” into a centrifugal device operating at a force of at least 5G (5 times the force of gravity) drives the separation of water drops (even of nano- and micro sized droplets) downstream of the pressure increasing device (e.g., pump, turbo-pump, compressor, or turbo-compressor) such that the now increased pressure creates saturated exhaust for water recovery (i.e., via effectively mechanical vapor recompression “MVR”). The now saturated exhaust enhances the ability for the compression to be more of the isothermal compression (which reduces the compression energy), and importantly a simple and effective method to reduce or eliminate the thermodynamic cycle fluid mass attributed to combustion products for energy recovery as well of the non-condensable gasses. The presence of any residual particulate matter (though not expected due to the very clean and complete combustion of hydrogen rich fuels) will also be expelled from the thermodynamic cycle fluid due to the higher density relative to the fluid. The centrifugal separation of saturated water maximizes the system capability especially when integrated to co-located drying, evaporating, or desalination thermal functions.

Though known in the art, direct drive from the power generation expander, to any compression of oxygen and/or hydrogen rich streams provides substantial (and necessary) safety enhancements by avoiding the potential for spark generation due to electrical motor/generator conversion in addition to the expense of an electrical generator and additional conversion losses as known in the art, and maximizing waste heat recovery with a BNCT that is greater than a BCT with the MVR. The absence of the combustion exhaust of a BCT substantially improves the amount of waste heat recovered upstream of the MVR with the BNCT.

The high saturation levels of the thermodynamic cycle fluid demand another inventive feature of the turbo-pump or turbo-compressor by leveraging ceramic rim-rotor blade architecture to achieve very high compression forces relative to the blade tensile forces. The inventive compression to tension force ratio on the turbomachinery blade is greater than 2:1 (and preferably greater than 5:1, and specifically preferred greater than 10:1), whether the rim-rotor architecture is used for compression or expansion.

The avoidance of combustion exhaust losses by using a BNCT (as compared to a BCT) enables operation of the thermodynamic cycle at higher low-side pressures (which reduces the size of expansion devices) enables a higher level of system waste energy converted to electrical energy (along with the thermal heating of organic matter entering a dual reactor electrolyzer “DRE”. As noted before, the integration of the DRE with the BNCT minimizes the dependency of electricity inputs from either intermittent renewable energy or grid interconnection dependencies (as typically required for water electrolysis to hydrogen electrolyzer operation). The electrical and thermal integration of BNCT with DRE increases the energy efficiency as compared to BCT with DRE.

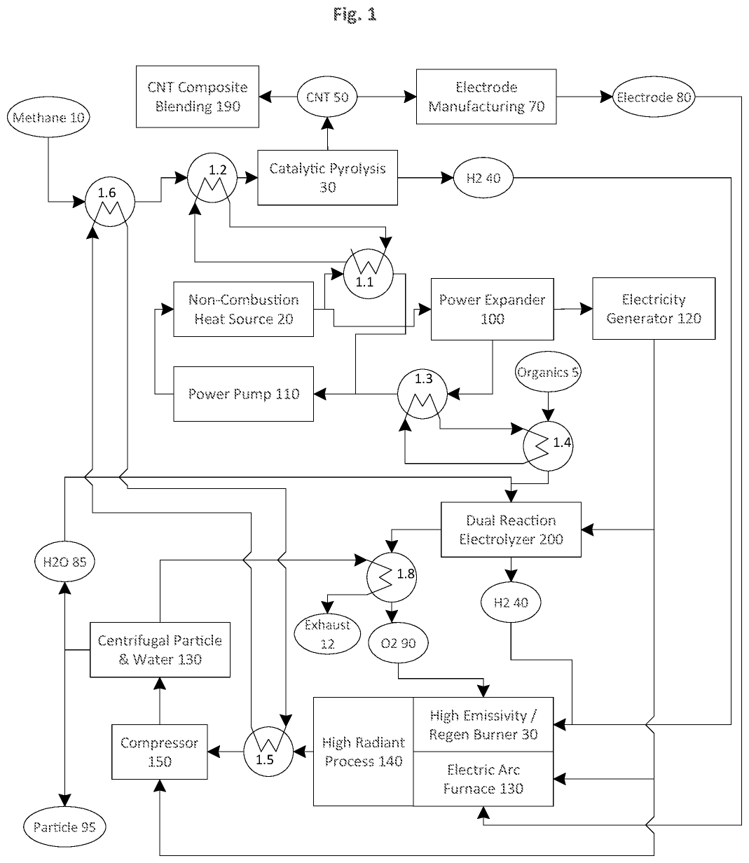

Turning to FIG. 1, FIG. 1 depicts a component view with supporting functional flows in a high emissivity operational mode of the BNCT. Beginning on the BNCT non-combustion heat (thermal) source 20 heats a heat transfer fluid (though recognized to be any liquid non-phase change fluid to a phase-change fluid such as carbon dioxide or steam, with the operating pressure dictating the transition temperature in combination with the fluid for liquid, saturated, subcritical or supercritical state) discharging to a heat exchanger 1.1 (though understood throughout the inventive system that virtually any indication of a heat exchanger external of the device removing heat or receiving heat can be substituted to also include an embodiment having direct heat transfer or placement of either or both the removing or receiving heat exchanger can be internal of the device) transferring heat via heat exchanger 1.2 into the catalytic pyrolysis “CP” 30 device for thermocatalytic disassociation (it is understood that the term disassociation can be used interchangeably with decomposition, and in all instances represents the breaking chemical bonds are broken) of methane 10 (or virtually any hydrogen containing organic matter). Heat exchanger 1.1 is at least 10 degrees Celsius (and preferably at least 50 degrees Celsius) hotter than the catalytic pyrolysis 30 temperature required for methane disassociation. The inventive embodiment operates the CP 30 device at a temperature higher than 500 C (and preferably higher than 600 C, but lower than 800 C and preferably lower than 750 C) and the heat transfer fluid leaving the non-combustion heat source 20 at an operating pressure preferably such that a phase-change from a gaseous state to a liquid state transitions at an approximately equivalent temperature in which the endothermic reaction of methane disassociation takes place for optimal hydrogen to methane ratio and carbon nanotube to amorphous carbon ratio (as amorphous carbon has substantially lower value than carbon nanotubes). The operation of the inventive system such that the phase change transition occurs within 20 C lower than the BNCT discharge temperature from heat exchanger 1.1 of the disassociation temperature (and preferably within 10 C of the disassociation temperature, and specifically preferred such that disassociation temperature of methane occurs in between the upstream temperature and the downstream temperature of the catalytic pyrolysis 30 device). The combined utilization of the BNCT (as compared to a BCT), especially when the variable “fuel” costs approach zero (e.g., less than $0.03 towards levelized cost of electricity, preferred less than $0.02, and particularly preferred less than $0.01) is operated in a feedforward control system mode to optimize for hydrogen production as the co-located host industrial processes become primary consideration as compared to incremental loss of power generation system energy efficiency. The creation of higher value co-products resulting from the catalytic pyrolysis 30 device (e.g., carbon nanotubes) further emphasizes the feedforward portion of the control system yet recognizing the importance of the feedback portion of the control system (dedicated to safe control of BNCT).

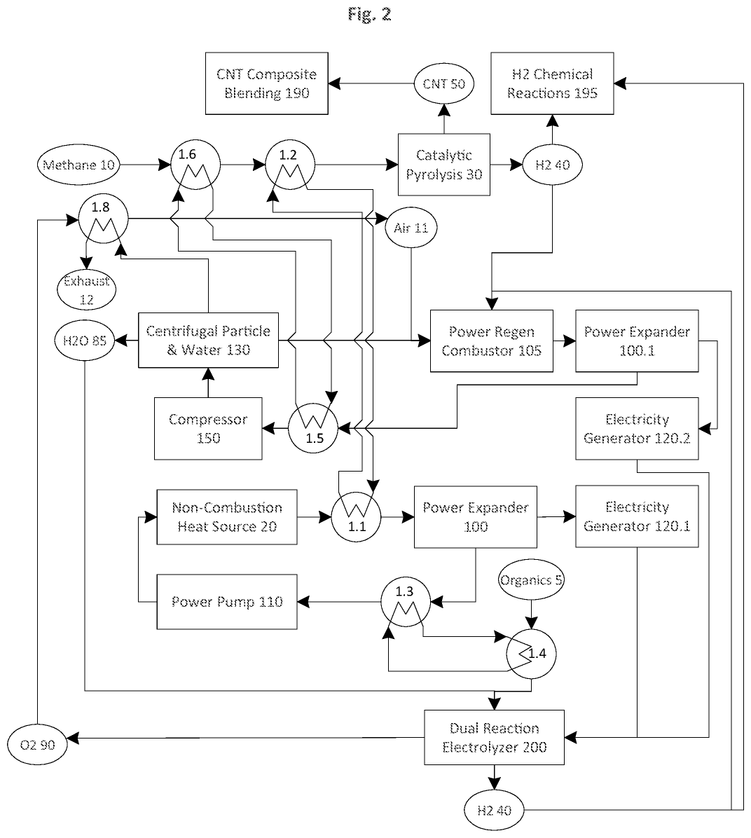

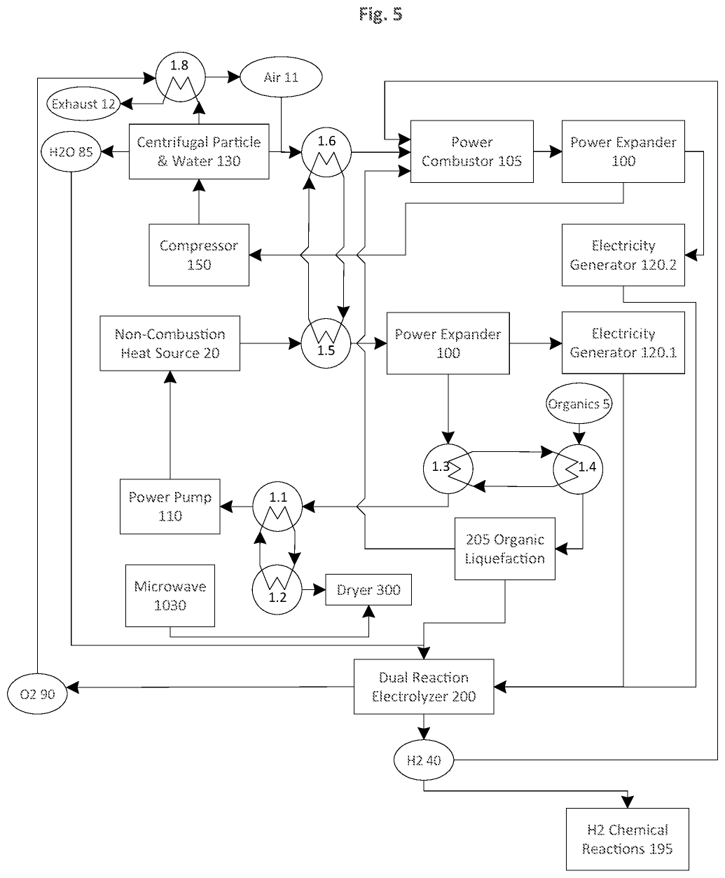

The heat transfer fluid from the non-combustion heat source 20 also flows to the power expander 100 such that the transition from high-pressure (the topside operating pressure of the thermodynamic cycle) across the expander 100 generates mechanical energy. It is understood that the heat transfer fluid, though shown as two distinct parallel flows to the catalytic pyrolysis 30 device and power expander 100 can in fact be in series (dependent on the operating temperature and pressure downstream of the non-combustion heat source 20) first passing to the catalytic pyrolysis 30 device and then to the power expander 100. The lack of combustion within the non-combustion heat source 20 uniquely enables the heat transfer fluid to directly return after heat transfer to heat exchanger 1.1 back to the non-combustion heat source 20 via a power pump 110 (as necessary to make up for any pressure drop, including variable speed control to dynamic respond to system perturbations). The mechanical energy created by the power expander 100 can be mechanically linked (as shown) to the electricity generator 120 (or as not shown directly coupled as known in the art as direct drive to a compressor, pump, etc. to avoid mechanical to electrical conversion losses). Heat exchanger 1.3, which effectively represents the condenser of the BNCT power generation thermodynamic cycle, transfers otherwise waste heat (preferably having a bottom side operating pressure such that the waste heat is transferred above 120 C, preferably above 140 C, particularly preferred between 150 C and 225 C, and more particularly preferred such that pressure and temperature combination is largely isothermal during the heat transfer) for preheating of organics 5 that are subsequently processed by a dual reaction electrolyzer “DRE” 200. It is understood that additional organic processing steps (e.g., pretreatment and/or liquefaction, such as shown in FIG. 5) can optionally be upstream of the DRE and also upstream of the heat exchanger 1.4 preheating organic matter 5 to enable a reduction of electricity required to produce hydrogen where the reduction is preferably at least a 5% reduction of electricity as compared to the non-preheated organic matter 5, and particularly preferred at least 10%, and specifically preferred at least 15%. The DRE 200 produces at least hydrogen “H2” by operating at a voltage sufficient for hydrogen production 40, and may optionally be operated at a higher voltage sufficient for concurrent oxygen “02” production 90 that is of particular objective when the BNCT is integrated into a high radiant process 140 having (and requiring) a high emissivity burner 30 to realize radiant heat transfer (of which without the hydrogen and preferred oxygen operating in an oxyfuel mode), as the non-inventive replacement of the BNCT with a BCT is not capable of achieving high radiant or high emissivity heat transfer (i.e., the peak operating temperature of the BNCT of less than 800 C and in preferred embodiment less than 650 C, and specifically preferred between 550 C and 800 C). The BNCT discharge temperature is preferably above 400 C, more preferred above 600 C, particularly preferred above 700 C and specifically preferred between 700 C and 800 C such that CNT to amorphous carbon ratio is greater than 2:1 (preferably greater than 4:1, and particularly preferred greater than 6:1) and importantly higher than the endothermic reaction temperature required to achieve the target CP 30 performance without requiring any hydrogen or methane combustion to directly drive the CP methane pyrolysis process (i.e., in other words, the inventive system is to thermally integrate either waste heat from a regenerative or recuperative process (as shown high radiant process 140, or as shown in FIG. 2 the top cycle power combustor 105 operating as a recuperative power generation cycle). Given that the catalytic pyrolysis 30 device creates on-site carbon nanotubes the inventive system is further capable of producing via the electrode manufacturing 70 process downstream of the carbon nanotube “CNT” 50 discharged into high performing electrodes (relative to graphite) 80 for electric arc furnace 130 operations (as known in the art as a standalone component). Dynamic variations of grid electricity prices, as well as variable demand for the aggregate electricity produced by the electricity generator 120 and the very low (if not virtually non-existent) variable fuel costs of the BNCT 20, varies the feedback portion of the control system because of the feedforward portion of the control system. The predominant (or preferred exclusive) utilization of hydrogen with the high radiant process(es) 140 yields combustion exhaust that is water vapor where residual waste heat is at least partially transferred upstream of the CP 30 process from heat exchangers 1.5 to 1.6 (having the benefit of both reducing the electricity required for compression, and then increasing the water separation via 130 such that at least a portion of the combustion products are removed for optimal reinjection back through the high emissivity burner 30 (though not shown, but in this instance operating as a regenerative burner with integral waste heat recovery). The compression stage by the compressor 150 (which can be of virtually any type or operational as a mechanical vapor recompression “MVR”) converts the exhaust into a saturated exhaust (i.e., condensed water droplets). Waste heat resulting from the heat of compression downstream of the compressor 150 is again preferentially utilized to preheat the oxygen stream 90 via heat exchanger 1.8. The preferred preheating operating temperature from waste heat recovery through heat exchanger 1.6 is more than 300 Celsius “C”, preferably greater than 400 C, particularly preferred greater than 600 C, and specifically preferred at least 20 C greater than the endothermic temperature that maximizes methane to carbon nanotube production (and disassociation of methane into hydrogen). It is understood that the resulting CNTs 50 can be preferentially blended, reacted, or subsequently processed into a CNT composite blend 190 on-site and particularly preferred with a product resulting from the high radiant process 140. Blending with the already heated CNTs and manufactured product from 140 further increases system energy efficiency by eliminating subsequent heating processes. The preferred embodiment of the carbon nanotube flow rate mixed with and into a co-located wet manufactured product has an evaporation rate of the co-located wet manufactured product at least 5 percent higher (and preferably 15 percent higher, and particularly preferred more than 30 percent higher) than the evaporation rate of the co-located wet manufactured product without any of the carbon nanotube flow rate mixed into the co-located wet manufactured product.

The further inventive step of utilizing a centrifugal particle and water separator 130 enables pure water “H2O” recovery 85 that can preferably be utilized within the DRE further ensuring water self-sufficiency especially when considering the naturally present water content in the organics 5 feedstock. Though not created by the hydrogen combustion process, residual particles 95 because of the high radiant process 140 (e.g., iron ore processing) are also separated by the separator 130. Non-condensed gases or water vapor downstream of the separator 130 still has thermal energy that is preferentially utilized (at least in part) to transfer that thermal energy via heat exchanger 1.5 into the resulting oxygen stream 90 recognizing that it is safer to preheat oxygen as compared to hydrogen, and then finally combustion exhaust 12 is discharged into atmospheric air (or not shown to any additional filtration steps required to meet regulatory emissions controls). Also not shown, but understood, the exhaust 12 with its remaining embedded thermal energy can be reinjected into the high emissivity burner as known in the art being a regenerative burner. The fundamental advantages of using the hydrogen fuel from either DRE and/or CP (i.e., including a hydrogen enriched source as compared to methane) enables very high levels of waste heat recovery for the high radiant process 140.

FIG. 1 is fundamentally the optimal configuration for operation of high radiant processes 140 notably and including metal smelters, steel making, glass manufacturing, cement plants, and oil refineries. Though not typically high radiant processes, high radiant processes 140 can be substituted by other processes that would benefit from reduced heat exchangers to achieve their operational temperatures particularly when those processes operate at higher pressures therefore having thick pressure vessel walls that otherwise would hinder heat transfer (especially when those processes require lower thermal conductivity stainless steel, etc.) such as Haber-Bosch ammonia production, hydrothermal liquefaction pretreatment of organic matter, or even infrared driven drying or cooking operations. Though not shown, it is understood that the hydrogen produced by the catalytic pyrolysis 30 and/or DRE 200 processes make exceed the requirement of the high radiant process 140 in which case that excess hydrogen can be utilized in processes as known in the art including power generation, ammonia production, hydrotreating or hydrocracking of fossil or preferably biofuels (including and notably biofuels at least partially upgraded by the DRE 200 process) collectively referred to as H2 chemical reactions 195 as shown in FIG. 2.

High emissivity is essential for high radiant heat transfer, a critical component of many industrial processes as known in the art, including steel, glass, cement, refinery operations, etc. Combustion provides significant residence time for air/oxygen and fuel to mix and for effective preheating of air/oxygen and fuel to mix to achieve homogeneous flameless combustion within the combustor and/or immediately thereafter within the boiler/furnace. The preferred combustion air temperature upstream of the buoyant combustor is above the autoignition temperature of the fuel, and preferably above 640 degrees Celsius.

Combustion of radiant energy with a post-combustor exhaust temperature greater than 700 degrees Celsius and a combustion internal of the combustor yields an emissivity greater than 0.20, a radiant flux greater than 100 KW per square meter, and combustion completion greater than 60% before combustor discharge. A preferred high emissivity is greater than 0.50, particularly preferred greater than 0.80, and specifically preferred greater than 0.90. And a preferred radiant flux is greater than 200 kW per square meter, particularly preferred greater than 350 KW per square meter, and specifically preferred greater than 450 KW per square meter. A combustion temperature is preferably greater than 900 degrees Celsius, particularly preferred greater than 1200 degrees Celsius, and specifically preferred greater than 1400 degrees Celsius.

It is understood that the heat transfer from heat exchanger 1.1, though shown on FIG. 1 and FIG. 2 as being from the low-pressure side of the BNCT power generation cycle, can be downstream of the power expander 100 and upstream of any other heat removal heat exchangers (operating as a condenser with respect to the power generation cycle) such as heat exchanger 1.3 (in FIGS. 1 and 2).

It is understood in terms of the multiple figures that some components are only shown in certain figures though the fundamental aspects of the invention remain in other figures when the “missing” components retain their relationship to the major components of BNCT, MVR, Dryer, CP, and DRE as specifically shown in the following figures.

Turning to FIG. 2, FIG. 2 has many similarities to FIG. 1 with the primary changes being the substitution of a high radiant process (140 as shown in FIG. 1) with a primary top cycle power generation system comprised of a power combustor 105, then power expander 100.1, then waste heat recovery heat exchanger 1.5 utilized to transfer thermal energy required for the endothermic catalytic pyrolysis 30 device through heat exchanger 1.6. The top cycle is operated at a pressure ratio for the expander 100.1 upstream pressure to the downstream pressure such that the discharge temperature post expander 100.1 is lower than by at least 10 degrees Celsius to the BNCT 20 discharge temperature (and preferably at least 20 C, particularly preferred at least 100 C, and specifically preferred at least 300 C). It is understood that this top cycle, though not shown, can include a recuperated thermodynamic cycle or an external combustor closed loop cycle such as supercritical steam or carbon dioxide cycle. But it is understood that the post expander 100.1 discharge temperature is not recuperated to a level where available waste heat exceeds endothermic energy required for methane disassociation. The second stage of methane heating to complete the endothermic energy requirements is provided directly by BNCT 20 through heat exchangers 1.1 and 1.2. Electricity from either or both electricity generators 120.1 and 120.2 as shown is used for DRE 200 to further produce hydrogen 40 and oxygen 90 utilized in the support of external hydrogen chemical reactions 195 or offsite hydrogen usage (not shown) and the oxygen is preferentially utilized to enable the top cycle power combustor 105 to operate in oxyfuel mode which maximizes thermodynamic cycle efficiency while minimizing (or preferentially completely avoiding) NOx formation. It is understood that every instance of hydrogen 40 and/or oxygen 90 (whether in this figure or every other instance in different figures) is optionally further comprised of a storage tank along with gaseous valve and gaseous valve controller(s) as known in the art to buffer the flow of respectively hydrogen and/or oxygen as well as decoupling the generation of hydrogen and/or oxygen from the consumption of hydrogen and/or oxygen particularly from the production of electricity. It is further understood, though not shown, is that any electricity resulting from and electricity generator 120 (or 120.1 or 120.2) can also be consumed by other on-site electricity consumers beyond the DRE 200 and/or electric arc furnace 130. Though not preferred, this embodiment does depict the potential to obtain some of the stochiometric oxygen requirement via atmospheric air 11. It is further understood, though not shown, that excess electricity can be used to support other co-located onsite demands or exported via deployable energy storage devices or through the utility grid (or microgrid). Common components and processes between FIGS. 1 and 2 reference the description in FIG. 1.

It is understood that the novel and distinct configurations shown in each prior and subsequent figure are the basis for further anticipated permutations and combinations of the BNCT 20, DRE 200, catalytic pyrolysis 30, and high radiant process 140 including their respective thermal integrations via heat exchangers.

Turning to FIG. 3, FIG. 3 as compared to FIGS. 1 and 2, eliminates the hydrogen production source of the catalytic pyrolysis 30 (not shown) to be solely the DRE 200. As noted in FIG. 2, common features, and components in FIG. 3 reference the appropriate descriptions of FIGS. 1 and 2. Waste heat via heat exchangers 1.3 to 1.4 (collectively as first stage condenser) from the BNCT 20 power generation cycle is utilized to preheat organic 5 processing notably the pretreatment of organic liquefaction 205 for subsequent processing in DRE 200. The bottom side of the cycle, notably the low-side pressure is optimized for heat transfer at the phase transition point within the necessary organic liquefaction 205 requirements (for preferred co-solvent enhanced liquefaction process in either the range 150 to 180 Celsius or the range 180 to 225 Celsius, or hydrothermal liquefaction in the range of 250 to 330 Celsius). The particularly preferred range is less than 160 Celsius to limit biomass conversion predominantly of hemicellulose hydrolysis and reduced condensation reactions of lignin while maximizing thermodynamic efficiency of the BNCT 20 power generation cycle. Additional waste heat is transferred via heat exchangers 1.2 to 1.1 (collectively as known in the art as second stage condenser) to preheat oxygen prior to blending (if necessary, though shown) with atmospheric air 11 to obtain sufficient oxygen for combustion. The inventive operation of this top cycle preferentially operates fuel rich where the non-combusted hydrogen is recirculated after having combustion exhaust of now saturated fluid post compressor 150 being desaturated via water removal in centrifugal particle & water separator 130. The utilization of both oxyfuel and hydrogen as the exclusive fuel source yields solely water as combustion product, which enables the inventive feature of operating the top cycle with a minimum fuel rich level of at least 2% beyond the stochiometric ratio (and preferably at least 5% beyond). In this manner the compressor 150 effectively operates as an MVR such that waste heat from the exhaust is captured inherently. The high level of water saturation in the working fluid of the top cycle, as noted before, further enables more isothermal compression to increase the net electrical efficiency. The utilization of the BNCT 20 cycle to drive the electrical demands of the DRE in combination with the top cycle operates utilizing the feedforward portion of the control to vary the operating flow of the DRE 200 and hydrogen utilization while the feedback portion of the control modulates the hydrogen and oxygen flows into the top cycle to ensure safe and synchronous operations. The inventive features of the combined BNCT 20 with DRE 200 yield a reduced carbon intensity for electrochemically converted organic matter to the same degree of intermittent solar and wind renewable energy sources but importantly onsite to eliminate demand charges, transmission losses, etc. with the further distinct advantage of oxyfuel top cycle. And the top cycle power generation components include a recuperated cycle that transfers within the thermodynamic cycle thermal energy downstream of the power expander 100.1 through heat exchangers 1.5 to 1.6 (collectively operating as the recuperator) upstream of the compressor 150 (that as known in the art can be a compressor of virtually any type but preferably a turbo-compressor). A further distinct feature of the BNCT 20 provides for a reduced carbon intensity of biofuels or specialty chemicals resulting from the subsequent DRE 200 processing or yet further processed by the resulting hydrogen 40 utilized in as known in the art hydrogen chemical reactions 195. The DRE 200 producing hydrogen using less than 10 kWh per kg (and preferably less than 8 kwh or particularly preferred less than 7.7 kWh per kg) and importantly the stochiometric production of oxygen “O2” 90 operationally integrated into the top cycle optionally blended with atmospheric air 11 for combustion in the power combustor 105 empowers higher system energy efficiency. Though not shown, it is understood that particularly in the favored operating range of combustor 105 discharge temperature above 1300 C the discharge temperature downstream of the recuperator is greater than 300 C can be utilized as additional heating to the oxygen 90 upstream of the combustor 105, or downstream of heat exchanger 1.4 and upstream of organic liquefaction 205, or even to further support endothermic reactions within the hydrogen chemical reactions 195.

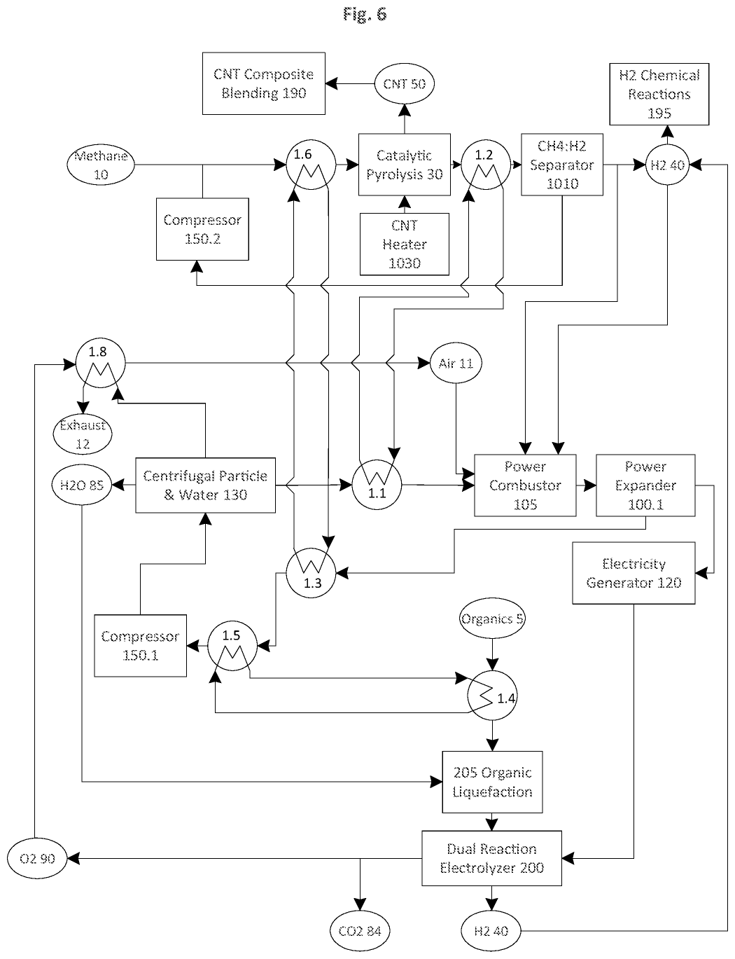

Though not explicitly shown in any of the figures an inventive further integration of the system is preferably electrically produced formic acid using excess electricity (whether sourced from the grid during interruptible rate discounted periods), with the subsequent usage of the resulting formic acid for in-situ hydrogen production within the organic liquefaction 205 process leveraging waste heat from either BNCT or recuperative power generation cycle occurring a formic acid decomposition temperature of less than 300 Celsius (and preferably less than 250 C) and specifically preferred using CNTs with copper and nickel catalyst (without post CNT catalyst removal) such that the CNTs with embedded copper and nickel catalyst that first enhances CNT fiber growth and importantly the resulting CNT with the same catalyst is utilized to catalyze reactions taking place within the organic liquefaction 205 process (as shown in FIG. 6) to further reduce by at least 5% and preferably by at least 15%, and specifically preferred by at least 80% char and tar formation. A yet further embodiment is the resulting formic acid is further included with tetrahydrofuran “THF” in at least one of the organic liquefaction 205 process and/or DRE 200 to further maximize lignin depolymerization with minimized lignin condensation reactions. The optimal combination of THF, formic acid, and CNT with copper and nickel catalysts both maximize lignin depolymerization and hemicellulose hydrolysis and then subsequent decarboxylation to upgrade the results from organic liquefaction through DRE into biofuels with concurrent hydrogen production while leveraging waste heat from either CP 30 or power generation downstream of expander 100.1. Two optimal regimes are: THF to water ratio of less than 2:1 through 1:1 (preferably 2:1), formic acid to pH adjust less than 2 (and preferably approximately 1.8), 5 mass percent of the biomass solids in the form of CNT with copper and nickel catalyst at an operating temperature of less than 250 Celsius (and preferably less than 200 C, and specifically preferred less than 160 C); and the other being THF to water ratio of less than 4:1 through 1:1 (preferably 3:1), formic acid to pH adjust less than 2 (and preferably approximately 1.2), 5 mass percent of the biomass solids in the form of CNT with copper and nickel catalyst at an operating temperature of less than 250 Celsius (and preferably less than 220 C, and specifically preferred less than 200 C). It is understood that in both instances the pH can be adjusted through a combination of formic acid and sulfuric acid. A yet preferred embodiment is the utilization of waste heat to distill THF (at a temperature greater than 60 C (and preferably greater than 80 C and less than 100 C) with MVR recompressing the THF for direct thermal injection of THF into organic liquefaction to eliminate external heating thus enabling direct hot THF injection (analogous to direct steam injection) heating simplifying the organic liquefaction to be essentially a pipe reactor in which the formic acid preferentially at the lower temperature regime enables removal of the hemicellulose via hydrolysis along with lignin solubilizing in the THF. This regime enables the fractionation of cellulose for subsequent use in which cellulose is converted in dissolved pulp, cellulose polymers, etc., while lignin is then preferentially processed in DRE via decarboxylation. It is further understood that oxalic acid can substitute formic acid within the lower temperature regime for hemicellulose hydrolysis. In the creation of formic acid, the preferred embodiment is the utilization of CO2 from DRE 200 being subsequently as known in the art to be electrochemically converted into formic acid. The further inclusion of magnesium hydroxide within the organic liquefaction process has the dual benefit of protecting the cellulose from hydrolysis while also being a superior electrolyte additive for the DRE process.

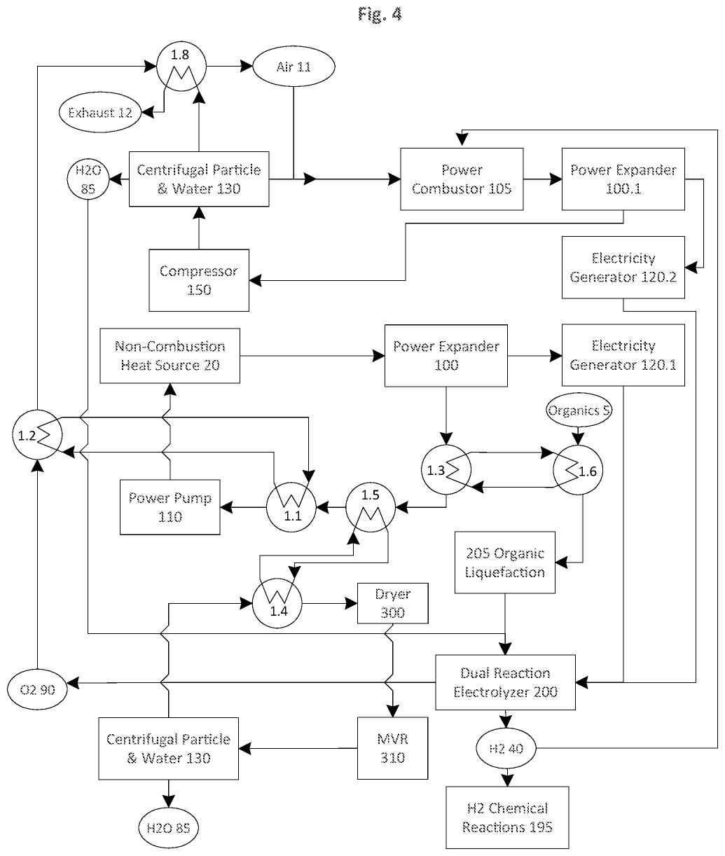

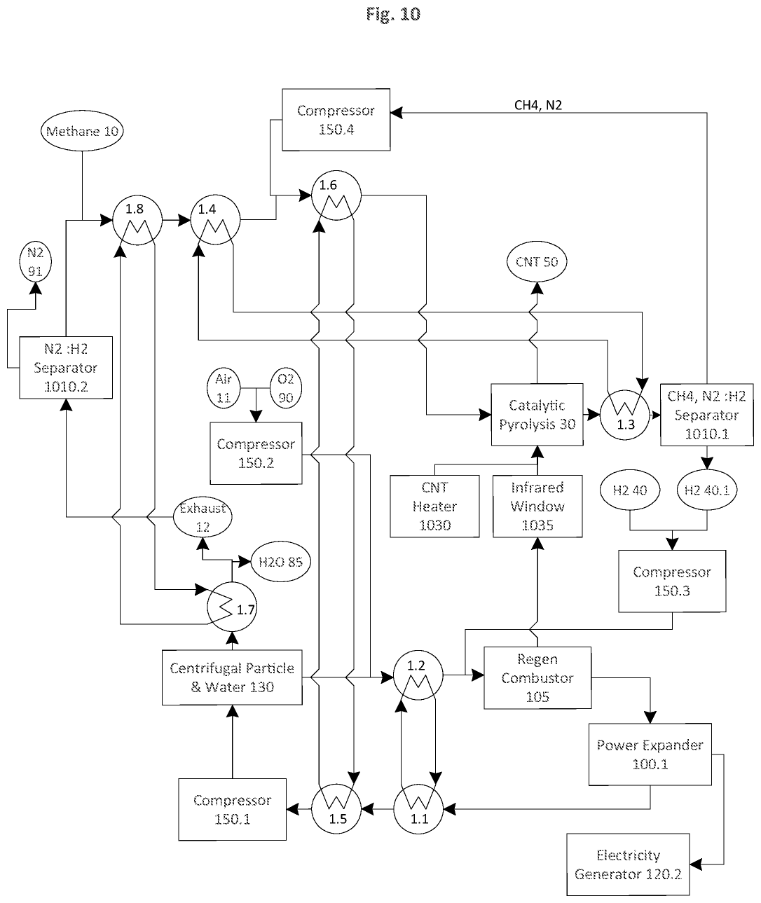

Turning to FIG. 4, FIG. 4 depicts the major components of DRE 200, BNCT (Non-Combustion Heat Source 20), and non-recuperative power generation cycle (power expander 100.1 being the conversion of thermal to mechanical and then electrical energy via Electricity Generator 120.2 that maximizes high-side power generation through a pressure ratio greater than 10, preferably greater than 15, and more specifically greater than 20). The inventive combination maximizes the system energy efficiency where the BNCT 20 again is critical to the aggregate energy efficiency by avoiding combustion exhaust, which is essential for multiple reasons including avoiding corrosion within heat transfer elements notably the condenser due to absence of combustion byproducts of nitrogen oxide(s) and sulfur oxide(s), the absence of phase change limits waste heat recovery when paired with the device utilizing that waste heat when in fact it has a phase change heat transfer fluid (notably the mechanical vapor recompression compressor 310). Beginning at the Non-Combustion Heat Source 20, whether it be from nuclear, LENR, geothermal, or solar sources, a portion of the thermal energy provides thermal energy both to its secondary power generation cycle (effectively a bottom cycle via power expander 100) and a thermally integrated primary power generation cycle (effectively a top cycle via power expander 100.1). The system, though not shown on this figure (as well as other figures), is understood to be capable of regulating flow via flow regulators or flow actuators (as known in the art) within each of the heat exchanger pairs (e.g., 1.1 and 1.2) including variable speed pumps and variable position flow valves. Additionally, these heat exchanger “pairs” can be heat pipes (either passive or active as known in the art) where the amount of heat transfer is precisely controlled by modulating the heat transfer fluid flow rate. The nature of BNCT particularly when the core source is both variable load as well as intermittent such as solar thermal energy as known in the art produces electricity through fluid expansion in the power expander 100 to drive the electricity generator 120.1 responsive to the quantity of thermal energy. If more electricity is demanded, especially during periods of time that command higher electricity prices, it is advantageous to transfer waste heat (i.e., another condensing stage) from the bottom cycle through heat exchanger 1.1 to the top cycle as incoming air preheat of oxygen 90, as generated by DRE 200 and preferably operating at the approximately the same (or incrementally higher by at least 0.5 psi) oxygen discharge pressure as discharge pressure from the top cycle compressor 150 (and when the oxidant source is not sufficient from the DRE fresh air 11 is supplemented, with a not shown air compressor compressing the fresh air 11 to approximately match the discharge pressure of the top cycle compressor 150). Operating the top cycle entirely within an oxy-fuel scenario leveraging both the DRE 200 hydrogen 40 and oxygen 90 products in this inventing manner enables the combination of the compressor 150 with centrifugal particle & water 130 separator to maximize energy cycle efficiency as the water vapor resulting from the combustion of hydrogen and oxygen is recompressed (similar to the MVR 310 shown in the lower portion of this figure, enabling the compressor 150 to operate in a substantially greater isothermal compression mode). The now saturated heat transfer fluid of the top cycle has now heated water 85, being separated from the remaining non-condensed vapor, utilized to reduce the electricity requirements to drive the DRE 200 by leveraging as known in the art by operating the DRE at a higher electrolyte temperature. Any excess combustion exhaust 12 products are discharged into the atmosphere after further recovering waste heat via heat exchanger 1.8 to further heat the incoming oxidant oxygen 90 downstream of heat exchanger 1.2. Continuing downstream of the power expander 100, the now low-pressure heat transfer fluid preheats organics 5 through the pair of heat exchangers 1.3 to 1.6 such that the heat from 1.3 is effectively a condenser for the bottom cycle and preheating of organics 5 pretreatment through organic liquefaction 205 (as known in the art to be hydrothermal liquefaction, co-solvent enhanced lignin fractionation, steam explosion, etc.) with a preferred fractionation of the resulting biocrude being isolated such that the lignin (or fats, oils, fatty acids) portion under goes chemical reaction in the DRE 200 preferably creating biofuels including gasoline, diesel, or sustainable aviation fractions with concurrent byproducts of hydrogen 40 (and dependent on voltage operation also oxygen 90 and not shown carbon dioxide). The inventive system utilizes feedforward controllers to determine the rate of hydrogen flow for co-located (preferably as H2 Chemical Reactions 195 including hydrotreating or hydrocracking) or off-site hydrogen processes. As already noted, the hydrogen 40 can be used as the fuel (preferably in combination with the resulting oxygen 90) for the top cycle via combustion in the power combustor 105 followed by downstream expansion within the power expander 100.1 that drives the electricity generator 120.2 (or as known in the art any direct-drive motor) including for the purpose of at least partially driving the DRE 200. The inventive combination as such operates in a net power (i.e., electricity) producing mode uniquely even when hydrogen is being produced via the DRE, whereas the traditional method of hydrogen generation has a round-trip electrical efficiency of less than 45%. Therefore, the inventive system can operate with an interruptible rate (when electing to be connected to a utility grid) to always avoid demand charges for operating the DRE and particularly preferred to always avoid peak energy rates. Though not shown, the top cycle can utilize the biocrude created downstream of the organic liquefaction 205 component when insufficient hydrogen is available as its operating fuel and/or when the value of using hydrogen for H2 Chemical Reactions 195 is greater than the incremental value of consuming biocrude. Downstream of the heat exchanger 1.3, with respect to the bottom cycle low-pressure side, additional waste heat (i.e., condenser) is transferred from heat exchanger 1.5 to 1.4 serving as superheat of the co-located waste heat via the mechanical vapor recompression “MVR” 310. The inclusion of the MVR 310 is particularly important as organics 5 are available (when not being consumed for electricity and waste heat purposes) for higher economic benefit by leveraging the biofuels creation with hydrogen as a byproduct thus obtaining power generation efficiencies greater than 40% (and preferably greater than 50%, and more specifically greater than 55% with system combined heat and power efficiencies greater than 93% and more specifically greater than 95%). Notably the inventive system is co-located in biomass manufacturing processes including pulping and sugar operations (which typically burn lignin byproducts first for its simple cycle i.e., only bottom cycle and then thermal energy such as pulp or sugar drying). The integration of BCNT 20 in combination with the MVR 310 increases the system efficiency substantially by the further inclusion of centrifugal particle and water separator 130 (which also reduces water usage) which not effective without the inventive combination of the DRE process for scale matching of biofuels and hydrogen production (both of which are traditionally much larger than pulp and sugar plant sizes). It is equally important for large-scale industrial processes to be co-located with BNCT operations as continuous operations within a base-load scenario accelerates the return on investment (becoming even more important as intermittent renewable energy is creating very low-priced energy sales for longer periods of time). Operating the MVR with the water separator 130 enables “open” recompression cycle reducing the amount of heat exchangers required as well as more full waste heat recovery. This being very important in biomass drying operations (e.g., wood, food) as well as thermal evaporation (including multi-stage) desalination. The combination of top cycle (hydrogen combustion) with non-combustion bottom cycle combined with on-site DRE for biofuels and hydrogen production achieves greater energy efficiency as compared to the use of a combustion driven bottom cycle. The preferred operating temperatures are like temperatures as noted in previous figures. Yet another benefit of the DRE being the production of hydrogen, though not shown in this figure but partially depicted in FIG. 10, is the inventive ability to enable an otherwise thermal temperature limited BNCT operating temperature to create high-radiant combustion within the top cycle for concurrent power generation and infrared heating with a much higher heat transfer as compared to BNCT alone (i.e., infrared flux rate of radiant combustion to infrared flux rate of non-combustion ratio of greater than 2:1, preferred greater than 5:1, and specifically preferred greater than 10:1). FIG. 4 predominantly references drying yet it is understood that the invention anticipates high radiant heat transfer into steel, cement, metal smelter, paper making, catalytic pyrolysis, distillation columns, refinery, and even baking operations which can't be achieved with only BNCT unless existing operations are replaced with expensive capital equipment for electrification in addition to the acquisition costs of BNCT.

Turning to FIG. 5, FIG. 5 depicts additional features beyond FIG. 4 notably the hydrogen resulting from the DRE 200 being used not just for H2 Chemical Reactions 195 but importantly for power generation (i.e., top cycle) using relatively speaking higher oxygenated fuels to displace power generation equipment operating on fossil fuels with a higher carbon to hydrogen ratio as well as carbon to oxygen ratio. In this exemplary hydrogen 40 from the DRE 200 is fed into the power combustor 105 to better approximate the previous design specifications of power generating equipment using fossil fuels. In this preferred instance, hydrogen produced on-site by the DRE 200 increases the carbon to hydrogen ratio of the biocrude to approximately 80% equivalence to the current fossil fuel (and preferably at least 85% equivalence, and specifically preferred to at least 85% equivalence of both carbon to hydrogen and hydrogen to oxygen ratio of the resulting biocrude to fossil fuel) with the preferred fossil fuel being marine bunker fuel or diesel fuel.

Furthermore, a portion of the heat transfer from the non-combustion heat source 20 is utilized to preheat incoming combustion air from heat exchanger 1.5 to 1.6 with the understanding that this implementation is done to maximize radiant heat transfer (as discussed and shown including in FIG. 4 and FIG. 10), reduce carbon dioxide emissions (even when the carbon source is biogenic as opposed to fossil-derived). A further goal of this embodiment is to match electricity demand and consumption enabling off-grid island mode of operation (or at least when forced to switch away from grid during high demand periods) while minimizing the on-site combustion of biocrude resulting from the organic liquefaction 205 process and therefore maximizing revenue generation by the higher value conversion of biocrude to biofuels. As noted before, biomass is often combusted to provide on-site power and thermal requirements with the previous operating mode of the “fuel’ source is a free byproduct of other operations (e.g., pulp, sugar, wood, etc.) and therefore known and more efficient electricity driven methods such as microwave drying (and though not shown MVR) are not implemented. The inventive integration of on-site biofuels and/or hydrogen production shifts this dynamic and therefore leverages the combined efficiency gains of microwave 1030 drying with existing known dryers 300 (plus of course MVR though not shown) by specifically leveraging waste heat from the BNCT cycle via heat exchanger 1.1 to 1.2 therefore combining (actually in most cases displacing waste heat from combustion processes) non-combustion waste heat and electrically driven microwave drying achieving a superior energy efficiency by at least 5% (and preferably at least 20%, and more specifically at least 30%) as compared to solely combustion heat source or microwave heat source. It is further anticipated by inclusion of a catalytic pyrolysis device creating carbon nanotubes (as shown in FIGS. 6, 10, and 12) the further inclusion of a portion of these resulting carbon nanotubes into the product (e.g., pulp, textile, clothing, plastic, etc.) being dried in the dryer 300 is particularly enhanced by high-radiant heat and more notably microwave heating that preferably heats carbon nanotubes. The latter scenario is particularly enabling for the creation of 3d parts and notably composites without requiring large ovens. The particularly preferred embodiment is focused microwave energy and carbon nanotubes within adhesion layers within a multi-ply laminate system. Other features as shown in this FIG. 5 are noted in previous descriptions of FIGS. 1-4. Therefore, it is again understood that more detailed descriptions of components shown in any figure explicitly uses the approximately equivalent descriptions from the other figures in establishing antecedent basis. The preferred embodiment of the microwave generator source increases the evaporation rate of a co-located wet manufactured product by at least 30 percent higher than the evaporation rate of the co-located wet manufactured product without any of the carbon nanotube flow rate mixed into the co-located wet manufactured product or without the microwave generator source or without the radiant combustion of the regenerative combustor.

Turning to FIG. 6, FIG. 6 depicts an embodiment of the DRE 200 with both a power generation cycle and catalytic pyrolysis system both operating with recuperation and all three operating with thermal integration. An important feature of the DRE 200 integration when the recuperated power generation cycle is closed loop as shown is byproducts of oxygen 90 and hydrogen 40 creating easily removed combustion byproducts of water, and yet the additional carbon dioxide 84 (which though not shown can be injected as a working fluid such that the heat transfer fluid within the recuperated power generation cycle can have at least 5% non-condensable gases, or at least 15% non-condensable gases, or at least 50% non-condensable gases) such that isothermal compression and expansion are maximized while at the same time operating at a higher energy density as known in the performance of supercritical carbon dioxide “CO2” cycle as compared to the steam cycle. Also, though not shown, the resulting CO2 84 from the DRE 200 can be used as an on-site CO2 supply when any of the power generating cycles are operating as supercritical CO2 (or trans-critical) power generating cycles therefore overcoming a known in the art issue of CO2 leakage from either or both the expander or compressor. The utilization of waste heat for the production of biofuels as shown here of heat transfer from heat exchangers 1.5 to 1.4 upstream of the organic liquefaction 205 process greatly overcomes a dominant issue of condenser operations of the supercritical CO2 power generation cycle, and also importantly enables the steam cycle to avoid low-side pressure of less than 1 atmosphere (therefore having a significant benefit of reduced size and number of stages in the expander 100.1). The utilization of the centrifugal particle and water separator 130 enhances the ease of combustion byproduct removal, and the DRE 200 producing on-site oxygen enables oxy-fuel combustion also having the benefit of all combustion byproducts being condensable gases. Inventive features are present by thermally integrating a catalytic pyrolysis “CP” 30 device (that produces carbon nanotubes “CNT” preferably as compared to amorphous carbon), though the thermal integration must be within the inventive operating temperature regime where the CP 30 operating temperature is less than 800 Celsius (and preferably less than 750 C, and particularly less than 700 C) and the recuperator of the power generation cycle has a compressor discharge temperature of less than 700 C (and preferably less than 600 C, and specifically preferred less than 400 C) such that gas temperature discharge from the CP 30 enables heat transfer via heat exchanger 1.2 to 1.1 respectively pre-cooling the gas temperature for subsequent hydrogen separation (as shown in methane “CH4”: hydrogen “H2” separator 1010) while preheating heat transfer fluid upstream of power combustor 105 (and downstream of centrifugal particle and water separator 130, though it is understood that within this figure and virtually all the figures that additional known in the art methods to condense water can be used interchangeably). The power generation cycle is operated on the low-side pressure such that waste heat via heat exchanger 1.3 is transferred downstream of the power expander 100.1 to preheat the methane 10 via heat exchanger 1.6, notably with the methane discharge temperature downstream of heat exchanger 1.6 within less than 100 degrees Celsius of the CP 30 downstream discharge temperature (and preferably within a range of less than 100 C and greater than 20 C, and more preferred within a range of less than 70 C and greater than 30 C) such that an additional external heat source CNT heater 1030 provides the bulk (at least 60%, and preferably at least 70%) of the endothermic reaction energy required to disassociate methane into hydrogen and carbon. The power generation cycle is further operated with a pressure ratio between the high-pressure side (upstream of the power expander 100.1) and low-pressure side (downstream of the power expander 100.1) of less than 12:1 for a 2-stage isothermal cycle, less than 4:1 for a 1-stage isothermal cycle, less 8:1 than a 2-stage Brayton cycle or less than 4:1 for a 1-stage Brayton cycle. The power generation cycle is also further operated with a post-expansion temperature (downstream of expander 100.1) greater than 400 C (and preferably greater than 500 C, and specifically preferred greater than 535 C). The preferred CNT heater 1030 emits a high energy intensity flux that selectively and preferably absorbed by the resulting CNTs to increase the CNT growth rate. A preferred CNT heater is driven by high-radiant combustion as compared to electrically driven microwave or resistance heating elements, as electricity is a more expensive energy source than radiant heat from combustion. The resulting CNTs 50 are utilized as known in the art including CNT composite blending 190, though preferred CNT production results in additional on-site utilization such that the inherent waste heat is utilized to further improve secondary operating energy efficiency. Though not explicitly shown, the CNTs produced on-site having as known in the art methods to improve thermal and electrical conductivity are utilized to enhance the energy efficiency of the organic liquefaction 205 process notably by enhancing heat transfer (to reduce by at least 5% the char and/or tar formation as compared to when CNTs are not included into the organics upstream of the organic liquefaction 205, and preferred to reduce by at least 20%, and particularly preferred to reduce by at least 80%). Maintaining the CNTs into the subsequent DRE 200 processing enhances electrical conductivity of the resulting liquefied organics to increase the electrochemical rate of reaction by at least 5% as compared to when CNTs are not included in the organics upstream of the DRE 200, and preferred to increase rate by at least 20%, and particularly preferred to increase rate by at least 50%). As noted already in FIG. 5 the resulting CNTs from the CP 30 process can be used to enhance drying or heating functions when included in pulp, plastic, ink, etc. Another inventive method of using the resulting CNTs are within the as known nanofluids within any of the power generation working fluids and/or heat transfer fluids. It is understood that the term working fluids can be used interchangeably with heat transfer fluids.

A more fundamental and inventive method of integrating the recuperative power generation cycle and the CP 30 is the inherent ability especially during CP startup conditions to leverage the power generation cycle equipment to remove oxygen from atmospheric air so as to provide a deoxygenated non-condensable gas (notably nitrogen) to enhance the CP methane to CNT conversion effectiveness, thus eliminating a dedicated source of nitrogen (or storage tank) to be provided in operations of the CP. The CP without the thermal integration of the recuperative power generation cycle produces an excess of non-recycled waste heat due to mass flow mismatch between methane upstream of the CP 30 and non-converted methane (and if dilution with nitrogen also the nitrogen) and even more so the endothermic energy required for methane disassociation, therefore the thermal integration with the recuperative power generation cycle in addition to the organic liquefaction 205 process and further the preheating of organics into DRE 200 all further increase the overall system efficiency. Another startup benefit is such that the CP 30 during its thermal ramp up to optimal CNT production growth rate, which is both transient in terms of system complexity and without the recuperative power generation system would require complex methane and lesser amounts of disassociated methane to be recirculated, where the increasing methane to hydrogen conversion can simply be used as operating fuel within the recuperative power generation system. In this manner the recuperative power generation system is operationally the preheater and heater for the CP 30 therefore reducing the capital cost as compared to a non-integrated solution. Also, in this manner the heated hydrogen 40 being discharged from the CP 30 reduces the size of the heat exchanger otherwise required to recover waste heat. Integration of the CP 30 all the way from recuperated power generation to organic liquefaction and then further into DRE 200 maximizes enthalpy efficiency.

Another embodiment of the CP 30 and the recuperated power generation cycle (i.e., without the organic liquefaction process and DRE) enables the power generation cycle to future ready for the global (and local) goals of being carbon zero emissions with predominantly control system changes to power generation plant operations. This embodiment eliminates the high-pressure storage tank required for hydrogen using the alternative medium pressure storage tank required for methane (compressed natural gas) therefore in the instance of being used for vehicles is a perfect range extender or hybrid power system. The on-site (or on-vehicle) manufacturing of CNTs resulting from CP operations in fact offsets by at least 20% (and preferably by at least 50%, and specifically preferred by at least 100%) the operating fuel costs. This embodiment also enables the power generation plant to operate in a rich fuel mode such that any fuel not combusted, whether it be hydrogen or methane, is inherently recirculated back through the CP 30.

In the manufacturing of CNTs especially for heat exchangers with through plane thermal management applications the optimal CNT growth is also within the through plane direction. The CP 30 in this instance has the catalyst embedded into a foil substrate, and preferably the embedded catalyst also provides desired alloying properties to the foil substrate (e.g., copper, nickel, zinc). The foil substrate is a roll-to-roll configuration such that foil is more rapidly preheated by the recuperative power generation cycle waste heat, with the catalyst having the highest temperature and the highest heat transfer via conduction. The resulting foil has greatly enhanced surface area because of the CNT growth and importantly superior heat transfer directly into the CNT fiber length. In this manner the resulting foil also has superior in-plane (i.e., thermal spreading) and then finally through-plane heat transfer. A derivative version of the CNT growth is such that catalyst is embedded within a substrate where the substrate is confined into an interior flow channel such that methane flows in the interior flow and the CNT grows from the substrate inward, which is the ideal method to increase surface area for heat transfer from a working or heat transfer fluid. The CP 30 has a controller that monitors pressure variation from the start of the interior flow channel to the end of the interior flow channel where the pressure drop provides real-time feedback of the amount of CNT growth.

Yet another advantage of the inventive integration is the second use of the catalyst post CP 30 utilization to enhance the growth of CNTs is superior thermal conductivity as the catalyst, without being bound by theory, being at the beginning of the CNT fiber enhances phonon transfer into the CNT fiber by at least 5% (and preferably by at least 15%, and specifically preferred by at least 25%) as compared to a CNT fiber in which the catalyst has been removed prior to any secondary utilization. Non-precious metal catalysts do not need to be recovered to make the CNT production process cost effective, and in fact particularly for thermal conductivity enhancements the presence of the metal catalyst enhances carbon to metal phonon interactions. It is anticipated that the catalyst prior to its secondary function is chemically cross-linked (i.e., functionalized) to enhance CNT dispersion (within liquids) or CNT adhesion (within monomers or polymers), or CNT reactions for polymerization processes.

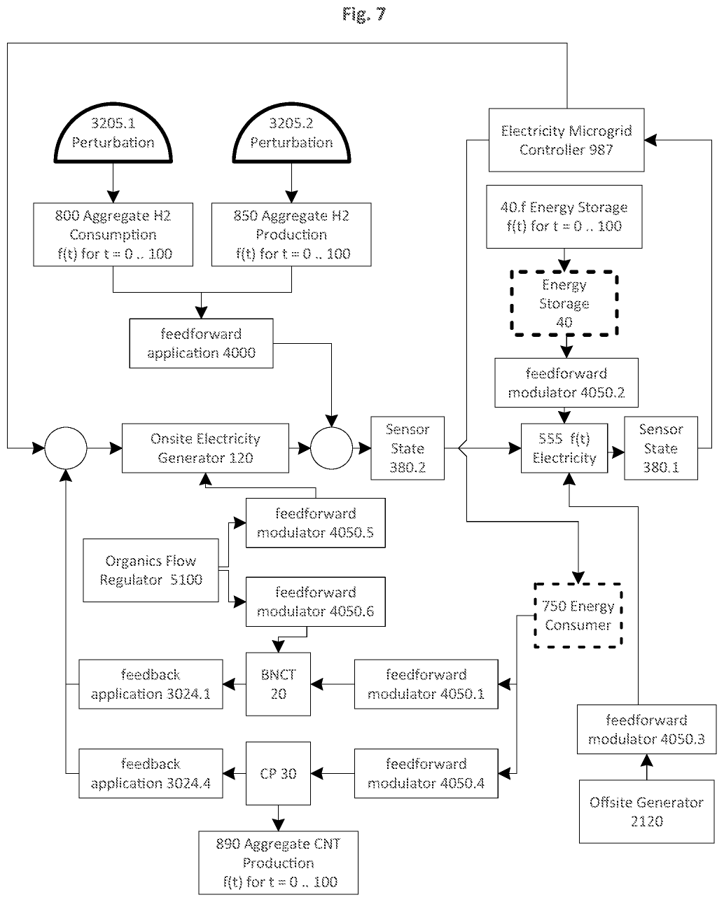

Turning to FIG. 7, FIG. 7 is the first embodiment of the feedforward with integral feedback control system of the inventive system. The interdependencies of the BNCT 20 and CP 30, also as shown in FIGS. 1 and 2, in terms of thermal energy transfer between processes and the further coupling of resulting hydrogen being utilized in DRE and high-radiant combustion further creates thermal interdependencies with at least one of BNCT 20 or CP 30. The varying cycle residence times between the BNCT (very fast in terms of electrical production, though marginally lower in terms of thermal lag) and CP (slower by at least a factor of 2, and in most instances by at least a factor of 10) is even further differentiated when factoring in other producers (shown as aggregate 850) or consumers (shown as aggregate 800) of hydrogen with their respective external perturbations (3205.2 and 3205.1) resulting in the feedforward portion of modulating the onsite generation 120 with feedforward modulator 4000. Specifically, the feedforward controller utilizes the predictive electricity production as a function of time “f(t)” including the parameters of hydrogen production f(t), hydrogen consumption f(t), real-time and forecasted value of electricity f(t) to modulate the consumption and production setpoints of electricity and hydrogen notably as shown from the CP 30, and further including the value of carbon nanotubes “CNT” resulting from the co-production of hydrogen. In fact, the operation of the onsite electricity generator 120 being the most time responsive consumer (i.e., at least 50 times a second, or in North America more commonly 60 times a second) of hydrogen as a method to reduce perturbations on CP operations. Furthermore, the production of electricity can also be rapidly charging or discharging from the electricity energy storage device(s) 40 with predicted modeling as a f(t) of the energy storage device(s) 40.f being modulated in a feedforward modulator 4050.2 to increase the aggregate amount of electricity produced 555. The onsite electricity generator 120 operates in a feedback mode, modulated by the feedforward parameters, to achieve full synchronization as well as maintaining safe operations particularly when the generators are turbomachinery using feedback sensors 380.2, real-time production of electricity 555, and electrical distribution sensors 380.1 all as inputs into the electricity microgrid controller 987 for both feedback and feedforward control operations. The electricity microgrid controller 987 directs the operation of the BNCT 20 via feedforward modulator 4050.1 and the CP 30 via feedforward modulator 4050.4 in respective combination with the feedback portions of the BNCT operations via feedback control 3024.1 and the CP operations via feedback control 3024.4. The feedforward portion is required due to the lagging response of thermal and hydrogen production interdependencies. The predicated rate structure and potential demand penalties incorporate predictive control of an offsite generator 2120 as modulated through the feedforward modulator 4050.3 considering the inventive co-production of hydrogen and CNTs (with predicted aggregate production of 890, therefore impacting revenue and income) by the CP 30. The specific aspect of the BNCT 20 operations, especially when the thermal source is either nuclear, solar, or geothermal has minimal variable operating costs and thus maximum operations at the real-time capacity including predictive electricity production as f(t) changes the feedforward modulator beyond the typical as known in the art utility rate structure. In other words, the operational capability for the resulting hydrogen production, without any real-time requirement of offsite generator capacity 2120, drives revenue production directly by production of CNTs and secondary utilization of the resulting hydrogen in upgrading of organics. On the other hand, critical shortages of electricity concurrent with demand penalties shift the feedforward controller into regulating the organics flow regulator 5100 through feedforward modulator 4050.5 for combustion by the onsite electricity generator 120 (in other words the penalty is greater than upgrade value of organics e.g., biocrude) and/or organics flowing as modulated by feedforward 4050.6 by thermal integration with the BNCT 20. The electricity microgrid controller 987 aggregates electricity consumption 750 for predictive and planned operations of the BNCT and CP.

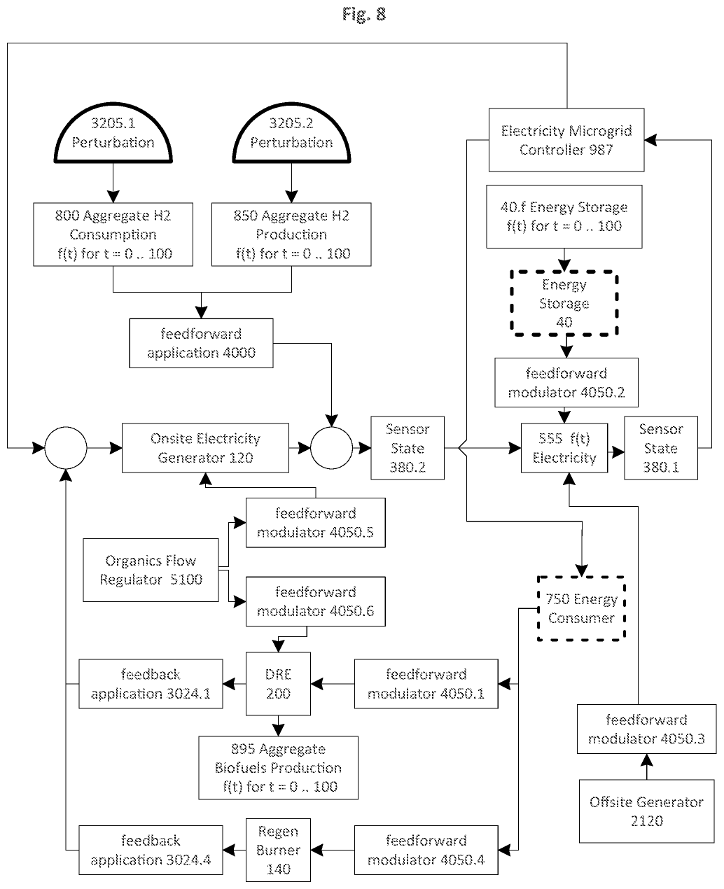

Turning to FIG. 8, FIG. 8 is approximately identical in configuration to FIG. 7 with the exception that the primary operating components of BNCT and CP are replaced respectively by the DRE 200 and RGP (or also anticipating a standalone operation of a regenerative burner component 140). Yet the drivers and decisions being accounted for by the feedforward portion of the electricity microgrid controller 987 are fundamentally different in large part due to the DRE 200 being a consumer of electricity rather than only a producer of hydrogen that can be used to produce electricity amongst its many purposes. Notably the DRE by operating dual reactions concurrently is a net producer of electricity even when the intermediary hydrogen immediately in real-time is used to produce electricity (i.e., round trip of electricity) fundamentally as differentiated from water electrolysis (world's best ^{˜}45 kWh consumed electricity to produce 1 kg of hydrogen, which if converted using world's best combined cycle power generation leads to only ^{˜}25 kWh meaning a net energy consumer of 20 kWh). The resulting hydrogen as produced by the DRE obtains more value in most instances by concurrently upgrading biocrude such as regulated flow by 5100 though the feedforward portion of the controller regulates non-upgraded biocrude (i.e., organics) particularly during periods of offsite electricity interruption (whether due to emergency, or planned interruptions especially when on the favorable interruptible rate schedule). The inventive utilization of hydrogen as produced by DRE to adjust the carbon to hydrogen, and hydrogen to oxygen ratio of the biocrude importantly enables biocrude to directly replace otherwise expensive fossil-derived diesel (or virtually any other fossil-derived fuel) such that the combination of the DRE and onsite electricity generator 120 operating on DRE derived hydrogen in real-time and biogenic biocrude achieves a further enhanced net positive electricity production. The revenue associated with the DRE upgrading biocrude (or just the lignin fraction) is an important element of the feedforward controller due to the typically much higher revenue and margin associated with aggregate biofuels production 895 as compared to electricity (especially during baseload or off-peak periods of time). The inventive system due to upgrading value of biofuels achieves at least 10% higher capacity factor for the onsite electricity generator 120 (and preferably at least 25% higher, and more specifically at least 50% higher) by electrically driving the DRE 200, as compared to a standalone electricity generator operating as known in the art as a “demand” peaker plant. The further diversion of DRE resulting hydrogen for combustion by the regenerative burner 140 introduces further complexity of the DRE operations including the thermal interdependencies of at least one of the onsite electricity generator 120 or regenerative burner 140 waste heat to further reduce the electricity demands of the DRE.

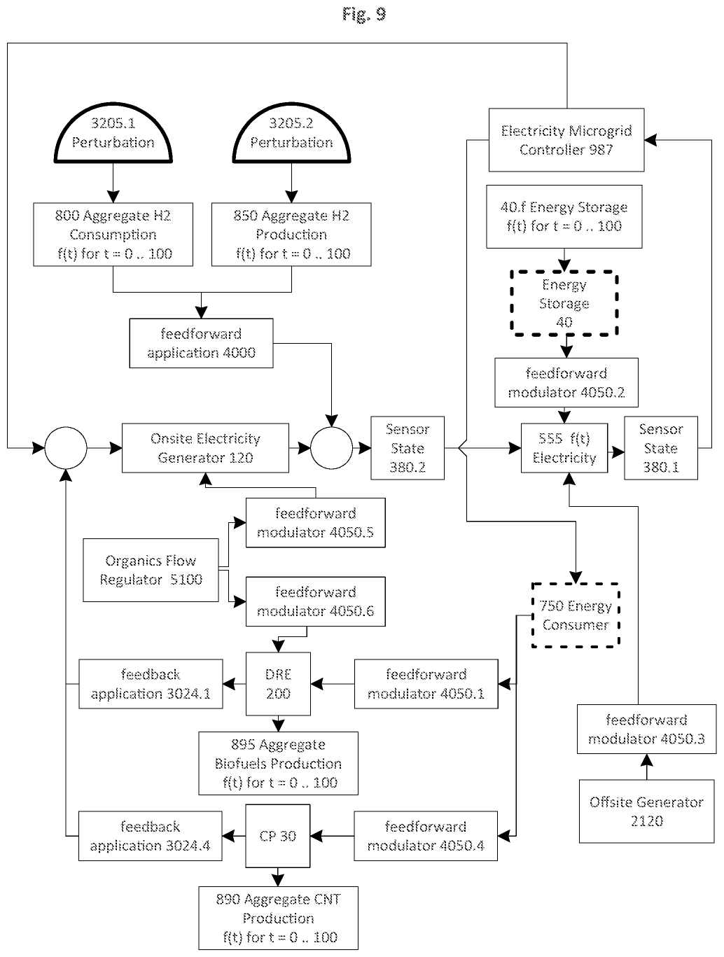

Turning to FIG. 9, FIG. 9 is approximately identical to FIG. 8 which substitutes the regenerative burner 140 with the CP 30. In this embodiment both the DRE 200 and CP 30 are producers of hydrogen whereas the regenerative burner 140 was a consumer. The aggregated CNT production as f(t) 890 plus the aggregated biofuels production as f(t) 895 is a primary revenue driver for the inventive system and therefore the feedforward portion of the electricity microgrid controller substantially increases the capacity factor of the onsite electricity generator 120. The inventive system due to upgrading value of biofuels via DRE 200 and carbon nanotubes via CP 30 achieves at least 10% higher capacity factor for the onsite electricity generator 120 (and preferably at least 25% higher, and more specifically at least 50% higher) by electrically driving the DRE 200, as compared to a standalone electricity generator operating as known in the art as a “demand” peaker plant. The preferred hydrogen flow rate from the dual reactor electrolyzer is higher than the hydrogen flow rate from the catalytic methane pyrolysis hydrogen producer by at least 5 percent, and the specifically preferred is by at least 15 percent.

Turning to FIG. 10, FIG. 10 depicts the CP with recuperative power generation cycle having the further addition of a nitrogen hydrogen separator 1010.2 to enable both rich fuel operations as well as non-oxy fuel operations. The recuperative power generation cycle maximizes thermal recuperation by transferring waste heat from downstream of the expander 100.1 to immediately upstream of the regenerative combustor/burner 105 via heat exchangers 1.1 to 1.2. Further waste heat from the power generation cycle is transferred via heat exchanger 1.5 upstream of the power generation compressor 150.1 to downstream of the compressor 150.4 for recirculation of non-converted methane with any nitrogen as reaction diluent via heat exchanger 1.6, where compressor 150.4 solely makes up for process pressure drop prior to the non-reacted methane and nitrogen diluent repeating an onstream pass of the CP 30 reactor. When the methane and nitrogen, and hydrogen separator 1010.1 requires a cooler inlet temperature as compared to the CP 30 discharge temperature a recuperated heat transfer takes place from heat exchanger 1.3 (downstream of CP 30, and upstream of separator 1010.1) to preheat new flow of methane with any residual non-combusted hydrogen (i.e., rich fuel mode) in which excess nitrogen is removed 91 that originates from the fresh air 11 (i.e., when not operating in 100% oxy-fuel mode, which occurs when insufficient oxygen 90 is available or operating economics effectively limits the oxygen availability). Hydrogen 40.1 isolated from the methane and nitrogen, hydrogen separator 1010.1, plus any additional hydrogen from a second source including storage 40, is compressed as necessary by compressor 40.1 to match approximately the operating pressure of the high side of the power generation system (i.e., the discharge pressure of compressor 150.1 minus any pressure drop resulting from the centrifugal particle and water separator 130, which isolates water 85 such as from hydrogen and oxygen combustion after removing thermal energy via heat exchanger 1.7 for preheating methane 10 via heat exchanger 1.8 downstream of the methane 10 inlet). Beyond the embodiment of FIG. 6, the further inclusion of an infrared transparent window 1035 enables (and optionally can modulate the flux) of infrared energy being emitted from the resulting high-radiant and high emissivity combustion at the high oxy-fuel temperatures (which can be further complemented by a CNT heat 1030 (e.g., microwave, or electric resistive or inductive heating element) to maximize catalyst and initial CNT growth on catalyst temperature so as to further encourage CNT fiber growth (i.e., to increase length of resulting fiber). The electricity generator 120.2 driven by direct mechanical coupling (or via gears though not shown) to the power expander 100.1 can be used in any manner (whether on-site or grid interconnect) though preferably to operate compressors (150.1, 150.2, 150.3, and/or 150.4, though it is understood as known in the art that the compressor 150.1 can operate on the same shaft as the expander 100.1). The system further includes a regulator to control removal of nitrogen (which can also include NOx resulting from the high temperature combustion) when atmospheric air 11 is utilized from the exhaust 12 (via a non-shown flow regulator). As detailed in other figures noting the feedforward with feedback controllers, flow regulators/modulators are utilized due to the strong interdependency of major subsystems through operating temperature, operating pressure, and ultimately the co-integrated hydrogen fuel production with power generation hydrogen fuel consumption especially in view of the lagging nature of fuel production versus fuel consumption.

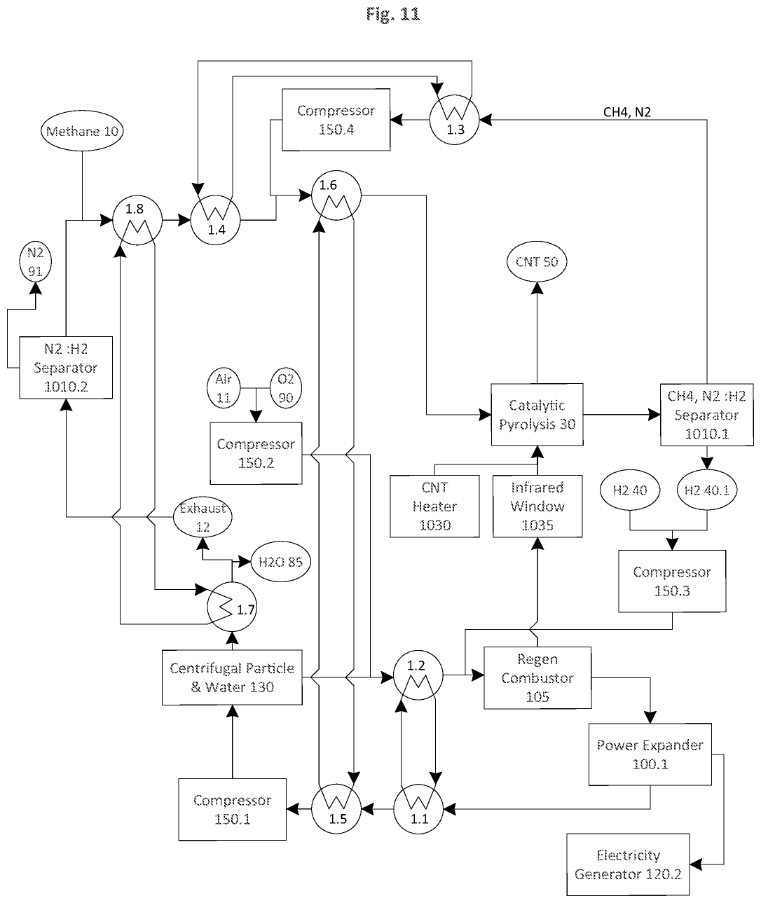

Turning to FIG. 11, FIG. 11 is like FIG. 10 in terms of major subsystems yet the absence of requiring upstream precooling by the methane with nitrogen (it is understood that functionality is similar with or without nitrogen diluent) and hydrogen separator 1010.1. As a result heat is removed upstream of the recirculation compressor 150.4 (so as to reduce compressor energy consumption) via heat exchanger 1.3 (upstream of compressor 150.4) with heat transfer into a first stage “heater” through heat exchanger 1.4 upstream of the CP 30 and the recuperated thermal energy of the power generation cycle via heat exchanger 1.6 (which is from waste heat downstream of the power generation recuperator (heat exchanger 1.1 to 1.2) and upstream of the power generation compressor 150.1. Additional heat transfer removes thermal energy from the exhaust stream 12 via heat exchanger 1.7 to further condense water vapor resulting from combustion of hydrogen and oxygen into water 85 with the recovered thermal energy being a first stage of preheating methane 10 via heat exchanger 1.8. As in the configuration of FIG. 10, the startup operating modes are virtually identical in the sense that the major subsystem of the recuperative power generation cycle provides approximately equivalent of otherwise required CP startup preheater, recuperator, high flux infrared emitter, and nitrogen supply that is already deoxygenated. Also, the recuperative power generator is best operated using oxy-fuel combustion mode with ceramic hot section (preferably rim-rotor architecture as known in the art). The further use of ceramic rim-rotor architecture for compressors is of particular importance for the compression of oxygen in addition to hydrogen and/or methane to avoid un-intended combustion within the respective compression stages. The preferred compressor 150.1 for the low-pressure side of the recuperative power generation cycle is critically a ceramic rim-rotor architecture to enable low erosion due to the otherwise highly saturated (by then condensed water) working fluid. The further preferred embodiment of the ceramic rim-rotor compressor is further comprised of flow diverter on the outward facing edge directly to the centrifugal particle and water separator 130, such that the flow diverter diverts preferably 100 percent of the condensed water droplets (or at least 80 percent) and the remaining water vapor or non-condensable gases are diverted back into the power generation cycle upstream of the recuperator 1.2 and regenerative combustor 105. The inventive methodology of deoxygenating atmospheric air without any cryogenic or pressure-swing adsorption measures as known in the art further combined with the CP converting methane into hydrogen when utilizing the deoxygenated atmospheric air is ideally suited for post-processing into ammonia including via the preferred microchannel reactive Haber-Bosch process that also becomes thermally integrated with the recuperative power generation “RPG” cycle. Ammonia is of particular importance as it enables the resulting ammonia to neutralize acids that are used in the organics pretreatment processes as well as organic liquefaction processes, such as through the use of sulfuric acid or preferred on-site production of formic acid particularly when the DRE or CP creates excess hydrogen and/or RPG creates excess electricity. In this same manner, excess hydrogen is utilized to transform furfural (resulting from hydrolysis of hemicellulose within organics notably lignocellulosic biomass) into tetrahydrofuran (via chemical reactions as known in the art). On-site production of ammonia and formic acid (or other carboxylic acids), including with the addition CNTs having embedded copper and/or nickel catalysts, enhances the self-sufficiency of the inventive system. The carbon neutral operations of BNCT as a thermal source for organics pretreatment and/or liquefaction shift the previous as known in the art practical requirement to maximize energy efficiency. The yet further inclusion of MVR and DRE further enable waste heat to be recovered and utilized within the integrated system.

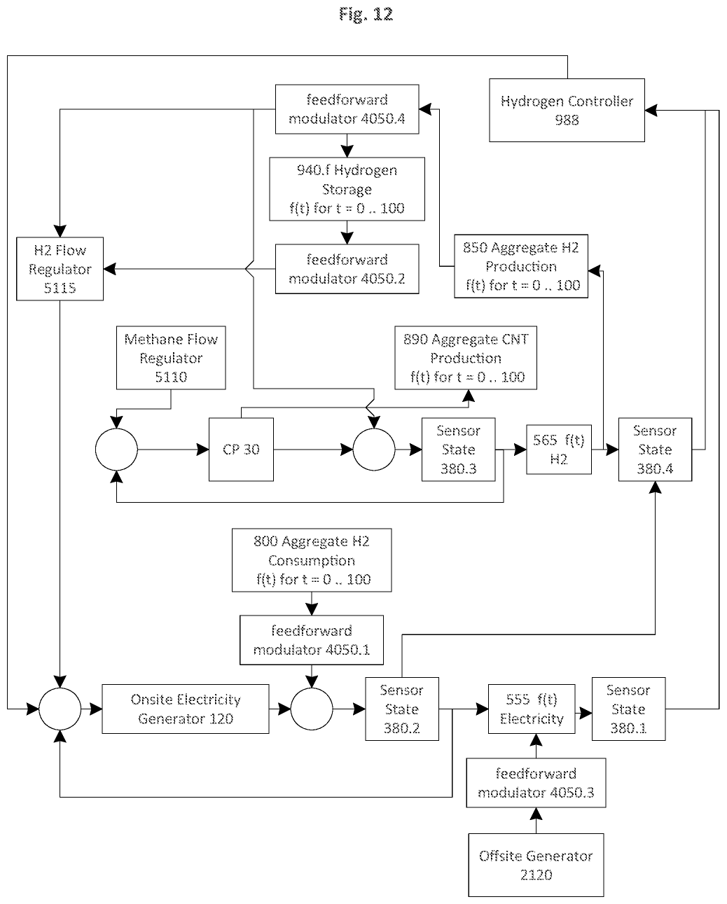

Turning to FIG. 12, FIG. 12 is the feedforward controller in which the CP 30, though producing a substantial amount of its operating revenue and margin by the production of carbon nanotubes aggregated as a function of time 890, also has primary on-demand electricity production requirements in most cases determined on a real-time basis. The time differential in terms of residence time and response time being substantially longer for the CP 30 operations demand feedforward control and not solely typical feedback control for electricity operations. In particular, the CP has significant sensitivity in terms of residence time, operating temperature, and pressure such that the CP creates carbon nanotubes (much higher value) as compared to amorphous carbon products (e.g., char, carbon black). As a result, including the thermal interdependencies and the great expense of storing hydrogen (i.e., compressor trains to compress hydrogen for storage into high-pressure storage tanks), the production of hydrogen from the CP needs to be precisely operated in a feedforward manner while ensuring adequate production of electricity by the onsite electricity generator 120. As noted elsewhere, the inventive onsite electricity generator 120 can utilize organics (e.g., biocrude preferably atomized using waste heat from the CP process, as well as onsite electricity generation 120) enhanced by hydrogen injection into the incoming combustion air (i.e., oxygen supply) for at least temporary increase of fuel availability to meet real-time electricity as f(t) demands 555 being aggregated by onsite electricity generator 120 and feedforward modulated input of 4050.3 for external supply of electricity from offsite generator(s) 2120 (i.e., the utility grid). In this embodiment hydrogen is the fungible and targeted constraint thus the hydrogen controller 988 manages the overarching feedforward parameters including sensor parameters 380.3 from the CP operations and sensor parameters 380.1 from the onsite electricity generator operations. The aggregate hydrogen consumption as f(t) 800 alters the feedback control of the onsite electricity generator by modulating the feedforward setpoints by 4050.1 and the traditional feedback parameters for synchronization and safe operations of sensor parameters 380.2. The operations of the CP, as noted is particularly sensitive to maintain the quality and form of the produced carbon products (e.g., carbon nanotubes) by utilizing known in the art sensor parameters 380.3 for the co-production of hydrogen as monitored as a f(t) in 565 being particularly important both during CP startup operations, onsite electricity generator startup (due to thermal interdependencies), or onsite electricity generator perturbations created due to emergency shutdown or fluctuations based on real-time electricity demands. External impacting sensors 380.3 are inputs to the feedforward hydrogen controller 988 including waste heat interdependencies created by the CP (as opposed to waste heat created by the onsite electricity generator that flow to the CP), real-time hydrogen production rate. The methane input into the CP 30 is regulated by the methane flow regulator 5110 with primary basis of maintaining quality of carbon products produced. The hydrogen flow regulator 5115 modulates in accordance with the feedforward modulator 4050.4 resulting from the CP production in combination with any hydrogen storage 940.f availability through feedforward modulator 4050.2 when CP hydrogen production is not adequate to meet the electricity demands. Though not shown, it is understood that methane can be used in a range of methane to hydrogen ratio (as controlled by hydrogen flow regulator 5115) from 100:1 through 1:100 in the onsite electricity generator 120 with the inherent understanding that carbon dioxide emissions will result due to the direct combustion of methane. The feedforward control portion is required to modulate the flow of methane either first through the CP for elimination of the carbon dioxide penalty, or even utilizing the combination of methane (i.e., non-converted) and hydrogen (i.e., converted) to the onsite electricity generator, or as just noted pure methane.

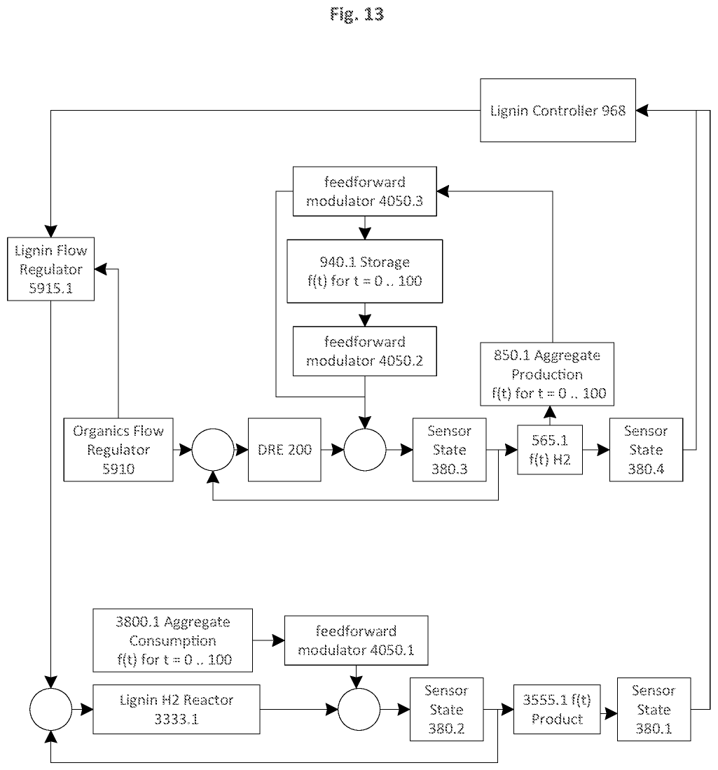

Turning to FIGS. 13, 14, and 15 all depict the feedforward control system specific to lignin which is one of the key components of lignocellulosic biomass (with the others being cellulose and hemicellulose) that is liquefied through the organic liquefaction 205 (as shown in other figures) along with the additional constituents as known in the art. The substantially varying rates of residence time for each of the major processes (e.g., DRE, CP, BNCT, Organic Liquefaction “OL”, and Recuperative Power Generation “RPG”) combined with the strong interdependencies both in terms of thermal transfer (i.e., to optimize system energy efficiency) and the byproducts (notably of the DRE) demands the inventive feedforward and feedback controller. Though not explicitly shown in the previous figures it is understood that storage tanks enable process perturbations to be dampened reducing the otherwise instantaneous valve, actuator, or regulator response however not alleviating the interdependencies. It is preferred that storage tanks are utilized with larger buffers for solid and liquid storage tanks relative to smaller buffers for gaseous storage tanks, in addition to subsequent co-located secondary processes that specifically consume through chemical reactions the gaseous products to further valorize the integrated system and to minimize otherwise requirements to down-regulate (i.e., reduce process throughput) the primary revenue generating outputs of the CP, DRE, BNCT, OL and RPG. The secondary co-located processes however create even more complexity as these chemical reactions also have varying rates of residence time as well. The feedforward controller, due to individual page space constraints of this patent filing, show the handling of hydrogen, carbon dioxide, and oxygen individually though it is understood that the lignin feedforward controller 968 can in fact operate as distinct for each gaseous product of DRE or more preferred such that lignin feedforward controller 968 makes feedforward adjustments considering concurrently all the gaseous products.

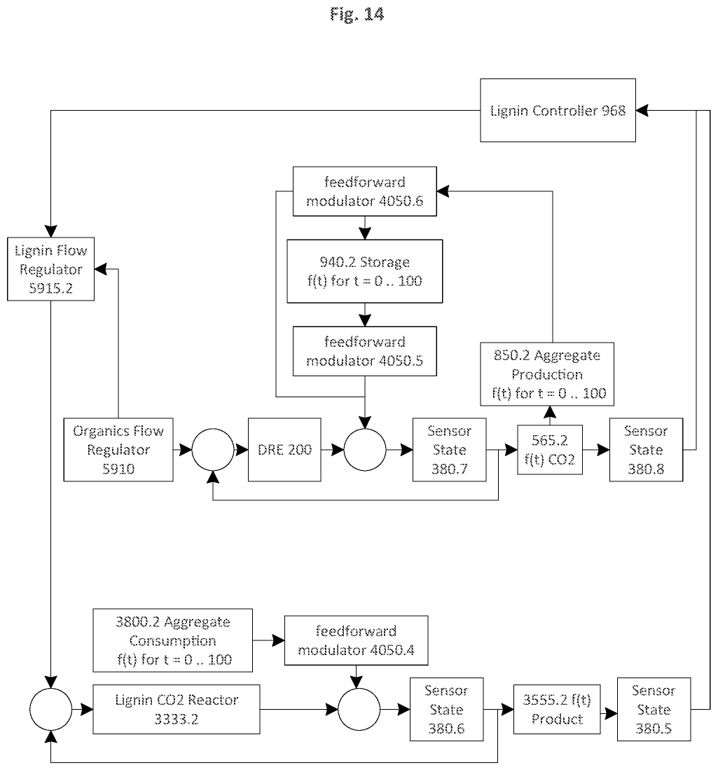

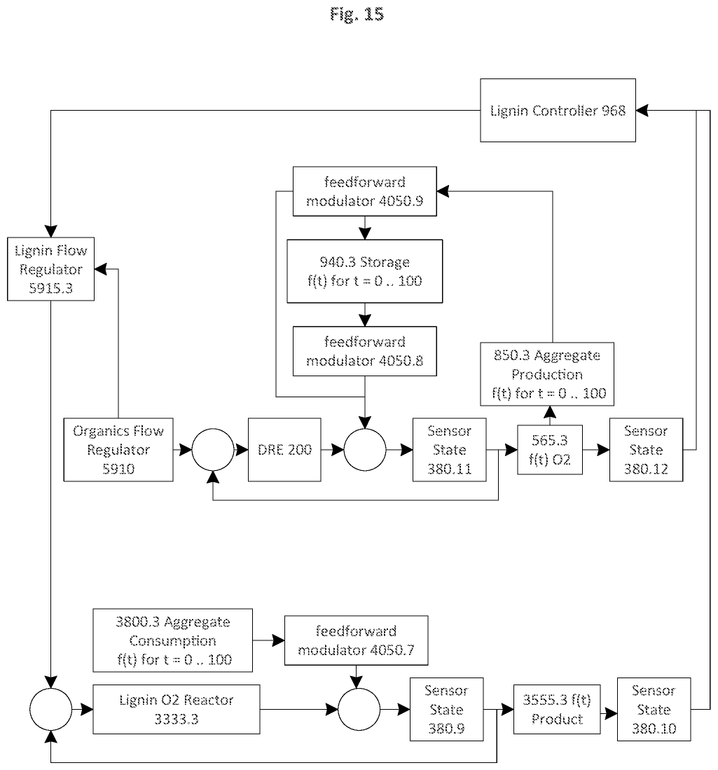

FIG. 13 specifically addresses hydrogen as the gaseous product resulting from the DRE 200 operations, though it is anticipated that other major processes (e.g., CP, RPG) that produce and consume hydrogen can be represented respectively into aggregate consumption 3800.1 or aggregate production 850.1 as a predictive function of time “f(t)” based on machine learning and/or digital twin of the processes as known in the art. Hydrogen, as well as oxygen (when in oxy-fuel mode), being consumed also for electricity (which is the fastest required response time, being at least 60 times per second) further requires a longer time horizon based on peak demand, interruptible rate and intermittent renewable energy. The lignin is sourced as a fractionated component from the organic (i.e., biomass) liquefaction process 205, though it is understood that the lignin is not required to be pure in most instances (and that the inventive system can have cellulose substituted for each of the FIGS. 13 through 15, as well as hemicellulose), with individual flow control through the organics flow regulator 5910 into either the DRE 200 for further upgrading (e.g., biocrude into biofuels) or through the lignin flow regulator 5915.1 (and/or as respectively shown in FIG. 14 and FIG. 15 through regulator 5915.2 and 5915.3) into lignin with hydrogen reactor 3333.1 (as shown being a single reactor, though understood that distinct flows can be provided for each type of lignin with hydrogen reactions). The feedback portion of the lignin controller 968 maintains the precise operating conditions required to perform the lignin with hydrogen reaction notably flow rate (i.e., residence time), temperature and pressure through monitoring of sensor states 380.2 (and/or as respectively shown in FIG. 14 and FIG. 15 through regulator 380.6 and 380.9), as well as co-injection of secondary reactants. As known in the art, such reactions include hydrotreating and hydrocracking. The feedforward portion of the lignin controller 968 establishes a feedforward modulator 4050.1 based on the predictive aggregate consumption f(t) 3800.1 such that precision of reaction conditions is maintained even when the rate of lignin and/or hydrogen are predicted in advance to change due to the multiple demands for hydrogen within the entire inventive system. The products of the lignin hydrogen reaction are monitored in real-time though 3555.1 along with additional process conditions through sensor state 380.1 becoming another set of inputs into the lignin controller 968. Additional portions of the feedforward controller consider the aggregate production of hydrogen 850.1 as a f(t), which as noted before can account for additional non-DRE sources of hydrogen (e.g., CP), accounting for availability of storage 940.1 as f(t) such that feedforward modulator 4050.2 enables hydrogen to be supplied to the reactor (not shown in terms of mass flow, but rather control logic is shown) from the storage tank 940.1 or directly from the DRE source of hydrogen as modulated between the storage tank 940.1 and DRE source through feedforward modulator 4050.3. The lignin controller 968 optimizes total system revenue and income, as well as accounting for any penalties due to supply deficiencies, to adjust for which processes will consume as f(t) lignin and hydrogen (as shown, and oxygen and carbon dioxide as shown in FIGS. 14 and 15). In this manner, the lignin controller modulates the DRE 200 in a feedforward manner also by the same aggregate production f(t) 850.1 combined with the predictive aggregate consumption of hydrogen 3800.1 as f(t) (and collectively aggregate consumption of oxygen more weighted than the aggregate consumption of carbon dioxide as f(t)) to modulate the rate of DRE through feedforward modulator 4050.1 and feedback loop via sensor state 380.2 monitoring and maintaining the precision temperature, pressure, voltage and current of the DRE such that the resulting products including hydrogen as produced and monitored by 565.1 as f(t). An additional set of DRE parameters are aggregated and shown as sensor state 380.4 yet additional inputs into the lignin controller 968. Operations of the DRE 200 is further modulated by accounting for the other feedforward controls as noted in previous figures, with DRE 200 operations being the most complex feedforward control system due to the wide range of processes that consume its products and its further interdependencies of inputs notably electricity and thermal waste heat.

FIG. 14 specifically addresses carbon dioxide as the gaseous product resulting from the DRE 200 operations that produce and consume carbon dioxide can be represented respectively into aggregate consumption 3800.2 or aggregate production 850.2 as a predictive function of time “f(t)” based on machine learning and/or digital twin of the processes as known in the art. Carbon dioxide can be consumed in multiple manners, both in terms of reaction chemistry as well as known in the art of photosynthesis notably microalgae growth. The noted CO2 consumption reactions tend to have very long residence times and microalgae specifically also has interdependencies of predictive solar intensity as f(t). The lignin is again sourced as a fractionated component from the organic (i.e., biomass) liquefaction process 205 with individual flow control through the organics flow regulator 5910 into either the DRE 200 for further upgrading (e.g., biocrude into biofuels) or through the lignin flow regulator 5915.2 into lignin with CO2 reactor 3333.2 (as shown being a single reactor, though understood that distinct flows can be provided for each type of lignin with CO2 reactions). The feedback portion of the lignin controller 968 maintains the precise operating conditions required to perform the lignin with carbon dioxide reaction notably flow rate (i.e., residence time), temperature and pressure through monitoring of sensor states 380.6, as well as co-injection of secondary reactants. As known in the art, such reactions include carbonation and carboxylation. The feedforward portion of the lignin controller 968 establishes a feedforward modulator 4050.5 based on the predictive aggregate consumption f(t) 3800.2 such that precision of reaction conditions is maintained even when the rate of lignin and/or carbon dioxide are predicted in advance to change due to demands for carbon dioxide within the entire inventive system. The products of the lignin carbon dioxide reaction are monitored in real-time though 3555.2 along with additional process conditions through sensor state 380.5 becoming another set of inputs into the lignin controller 968. Additional portions of the feedforward controller consider the aggregate production of carbon dioxide 850.2 as a f(t), which as noted before can account for additional non-DRE sources of carbon dioxide (e.g., combustion of fossil or biofuels), accounting for availability of storage 940.2 as f(t) such that feedforward modulator 4050.5 enables carbon dioxide to be supplied to the reactor (not shown in terms of mass flow, but rather control logic is shown) from the storage tank 940.2 or directly from the DRE source of carbon dioxide as modulated between the storage tank 940.2 and DRE source through feedforward modulator 4050.6. The lignin controller 968 optimizes total system revenue and income, as well as accounting for any penalties due to supply deficiencies, to adjust for which processes will consume as f(t) lignin and carbon dioxide. In this manner, the lignin controller modulates the DRE 200 in a feedforward manner also by the same aggregate production f(t) 850.2 combined with the predictive aggregate consumption of carbon dioxide 3800.2 as f(t) (and collectively aggregate consumption of hydrogen more weighted than the aggregate consumption of oxygen as f(t)) to modulate the rate of DRE through feedforward modulator 4050.5 and feedback loop via sensor state 380.6 monitoring and maintaining the precision temperature, pressure, voltage and current of the DRE such that the resulting products including carbon dioxide as produced and monitored by 565.2 as f(t). An additional set of DRE parameters are aggregated and shown as sensor state 380.8 yet additional inputs into the lignin controller 968. Operations of the DRE 200 is further modulated by accounting for the other feedforward controls as noted in previous figures, with DRE 200 operations being the most complex feedforward control system due to the wide range of processes that consume its products and its further interdependencies of inputs notably electricity and thermal waste heat. A particular inventive feature when the lignin is processed with carbon dioxide (or other as known in the art lignin-based polymers) is the direct inclusion of CNTs from the CP with or without retaining the catalyst embedded carbon nanotubes with the resulting polymers (also anticipated to be non-lignin derived polymers) such that the CNTs increase polymer technical performance (e.g., stronger, lighter, etc.) during the useful lifetime of the polymer and very importantly enable a second repurposing phase of those polymers where the embedding of the CNTs enhance the depolymerization process by increasing electrical and thermal conductivity both of importance when a first DRE performs the depolymerization that has at least 5 percent faster reaction rates (as compared to the same polymer without CNTs, and preferably at least 15 percent faster, and specifically preferred at least 30 percent faster) then uses the resulting carboxylic acids or monomers as an organic feedstock for a second DRE (as detailed in this inventive embodiment). The presence of the CNTs continues its multifunctional life as a catalyst within other lignocellulosic or organics feedstock void of CNTs.

Yet another embodiment of the fundamental inventive integration of organic liquefaction and CP, though not explicitly shown, is the often-typical presence of biogenic silica ash from lignocellulosic biomass (notably corn stover, rice husk, energy crops). The fractionated silica ash is typically porous being an ideal substrate for CP resulting in a silicon carbide fiber/whisker having as known in the art uses.

FIG. 15 specifically addresses oxygen as the gaseous product resulting from the DRE 200 operations into aggregate consumption 3800.3 or aggregate production 850.3 as a predictive function of time “f(t)” based on machine learning and/or digital twin of the processes as known in the art. Oxygen can be consumed in multiple manners notably oxidation reaction chemistry. The lignin is again sourced as a fractionated component from the organic (i.e., biomass) liquefaction process 205 with individual flow control through the organics flow regulator 5910 into either the DRE 200 for further upgrading (e.g., biocrude into biofuels) or through the lignin flow regulator 5915.3 into lignin with oxygen reactor 3333.3 (as shown being a single reactor, though understood that distinct flows can be provided for each type of lignin with oxygen reactions). The feedback portion of the lignin controller 968 maintains the precise operating conditions required to perform the lignin with oxygen reaction notably flow rate (i.e., residence time), temperature and pressure through monitoring of sensor states 380.9, as well as co-injection of secondary reactants. As known in the art, such reactions include combustion, aerobic digestion, etc. The feedforward portion of the lignin controller 968 establishes a feedforward modulator 4050.8 based on the predictive aggregate consumption f(t) 3800.3 such that precision of reaction conditions is maintained even when the rate of lignin and/or oxygen are predicted in advance to change due to demands for oxygen within the entire inventive system. The products of the lignin oxygen reaction are monitored in real-time though 3555.3 along with additional process conditions through sensor state 380.10 becoming another set of inputs into the lignin controller 968. Additional portions of the feedforward controller consider the aggregate production of carbon dioxide 850.3 as a f(t), which as noted before can account for additional non-DRE sources of oxygen (e.g., electric arc furnaces, photosynthesis), accounting for availability of storage 940.3 as f(t) such that feedforward modulator 4050.8 enables carbon dioxide to be supplied to the reactor (not shown in terms of mass flow, but rather control logic is shown) from the storage tank 940.3 or directly from the DRE source of oxygen as modulated between the storage tank 940.3 and DRE source through feedforward modulator 4050.9. The lignin controller 968 optimizes total system revenue and income, as well as accounting for any penalties due to supply deficiencies, to adjust for which processes will consume as f(t) lignin and oxygen. In this manner, the lignin controller modulates the DRE 200 in a feedforward manner also by the same aggregate production f(t) 850.3 combined with the predictive aggregate consumption of oxygen 3800.3 as f(t) to modulate the rate of DRE through feedforward modulator 4050.8 and feedback loop via sensor state 380.9 monitoring and maintaining the precision temperature, pressure, voltage and current of the DRE such that the resulting products including oxygen as produced and monitored by 565.3 as f(t). An additional set of DRE parameters are aggregated and shown as sensor state 380.12 yet additional inputs into the lignin controller 968. Operations of the DRE 200 is further modulated by accounting for the other feedforward controls as noted in previous figures, with DRE 200 operations being the most complex feedforward control system due to the wide range of processes that consume its products and its further interdependencies of inputs notably electricity and thermal waste heat.

While the invention has been described in connection with various embodiments, it will be understood that the invention is capable of further modifications. This application is intended to cover any variations, uses or adaptations of the invention following, in general, the principles of the invention, and including such departures from the present disclosure as, within the known and customary practice within the art to which the invention pertains.

What is claimed is:

1. A regenerative production system of hydrogen consisting of:
a dual reactor electrolyzer having a first chemical reaction on the cathode side of the dual reactor electrolyzer;
the dual reactor electrolyzer having a second chemical reaction on the anode side of the dual reactor electrolyzer;
a regenerative combustor producing a radiant combustion with a high emissivity of at least 0.5; and
whereby the first chemical reaction on the cathode side produces a hydrogen flow and wherein the dual reactor electrolyzer has an electricity consumption rate of less than 12 kWh of electricity per kilogram of the hydrogen flow.

2. The regenerative production system of hydrogen as claimed in claim 1 whereby the second chemical reaction on the anode side of the dual reactor electrolyzer produces an oxygen flow to the regenerative combustor.

3. The regenerative production system of hydrogen as claimed in claim 2 whereby the regenerative combustor produces a waste heat exhaust and wherein the waste heat exhaust reduces the electricity consumption rate to less than 7.7 kWh of electricity per kilogram of the hydrogen flow.

4. The regenerative production system of hydrogen as claimed in claim 2 whereby the regenerative combustor produces a waste heat exhaust and wherein the waste heat exhaust reduces the electricity consumption rate to less than 3 kWh of electricity per kilogram of the hydrogen flow.

5. The regenerative production system of hydrogen as claimed in claim 1 whereby the radiant combustion of the regenerative combustor has a radiant flux greater than 300 kW per square meter and the high emissivity greater than 0.60.

6. The regenerative production system of hydrogen as claimed in claim 2 further consisting of a first feedback control loop regulating an electrical consumption rate to the dual reactor electrolyzer, a second feedback control loop regulating a hydrogen consumption rate to the regenerative combustor, a feedforward signal modulating the oxygen flow rate between a first regenerative combustor of a high radiant manufacturing process and a second regenerative combustor of a high temperature ceramic power generation turbine producing electricity to minimize an aggregate hydrogen flow comprised of the hydrogen flow rate to the high radiant manufacturing process and to the high temperature ceramic power generation turbine.

7. The regenerative production system of hydrogen as claimed in claim 1 further consisting of a catalytic methane pyrolysis hydrogen producer, whereby an endothermic energy source is required to produce a hydrogen flow rate from the catalytic methane pyrolysis hydrogen producer and whereby the catalytic methane pyrolysis hydrogen producer obtains at least 70 percent of endothermic energy source from a waste heat source of the regenerative combustor.

8. The regenerative production system of hydrogen as claimed in claim 7 further consisting of a feedforward signal modulating a hydrogen flow rate from the dual reactor electrolyzer and the catalytic methane pyrolysis hydrogen producer, and whereby the feedforward signal modulating the hydrogen flow rate from the dual reactor electrolyzer is higher than the hydrogen flow rate from the catalytic methane pyrolysis hydrogen producer by at least 5 percent.

9. The regenerative production system of hydrogen as claimed in claim 7 further consisting of a feedforward signal modulating a hydrogen flow rate from the dual reactor electrolyzer and the catalytic methane pyrolysis hydrogen producer, and whereby the feedforward signal modulating the hydrogen flow rate from the dual reactor electrolyzer is higher than the hydrogen flow rate from the catalytic methane pyrolysis hydrogen producer by at least 15 percent.

10. The regenerative production system of hydrogen as claimed in claim 7 whereby the catalytic methane pyrolysis hydrogen producer concurrently produces a carbon nanotube flow rate, whereby the carbon nanotube flow rate is mixed into a co-located wet manufactured product, and whereby the carbon nanotube flow rate mixed into the co-located wet manufactured product has an evaporation rate of the co-located wet manufactured product at least 5 percent higher than the evaporation rate of the co-located wet manufactured product without any of the carbon nanotube flow rate mixed into the co-located wet manufactured product.

11. The regenerative production system of hydrogen as claimed in claim 7 whereby the catalytic methane pyrolysis hydrogen producer concurrently produces a carbon nanotube flow rate, whereby the carbon nanotube flow rate is mixed into a co-located wet manufactured product, and whereby the carbon nanotube flow rate mixed into the co-located wet manufactured product in combination with the radiant combustion of the regenerative combustor has an evaporation rate of the co-located wet manufactured product is at least 15 percent higher than the evaporation rate of the co-located wet manufactured product without any of the carbon nanotube flow rate mixed into the co-located wet manufactured product.

12. The regenerative production system of hydrogen as claimed in claim 7 whereby the catalytic methane pyrolysis hydrogen producer concurrently produces a carbon nanotube flow rate, whereby the carbon nanotube flow rate is mixed into a co-located wet manufactured product, and whereby the carbon nanotube flow rate mixed into the co-located wet manufactured product in combination with the radiant combustion of the regenerative combustor has an evaporation rate of the co-located wet manufactured product is at least 30 percent higher than the evaporation rate of the co-located wet manufactured product without any of the carbon nanotube flow rate mixed into the co-located wet manufactured product.

13. The regenerative production system of hydrogen as claimed in claim 12 further consisting of a microwave generator source whereby the evaporation rate of the co-located wet manufactured product is at least 30 percent higher than the evaporation rate of the co-located wet manufactured product without any of the carbon nanotube flow rate mixed into the co-located wet manufactured product or without the microwave generator source or without the radiant combustion of the regenerative combustor.

14. The regenerative production system of hydrogen as claimed in claim 1 further consisting of a non-combustion thermal source producing electricity, whereby the non-combustion thermal source producing electricity is operating a regenerative thermodynamic cycle, and whereby the non-combustion thermal source obtains an additional thermal energy source from the waste heat of the regenerative combustor.

15. The regenerative production system of hydrogen as claimed in claim 14 whereby the non-combustion thermal source producing electricity has a power generator expander, an upstream expander inlet flow has an expander flow temperature to the power generator expander, and whereby expander flow temperature is greater than 400 Celsius.

16. The regenerative production system of hydrogen as claimed in claim 14 whereby the non-combustion thermal source producing electricity has a power generator expander, an upstream expander inlet flow has an expander flow temperature to the power generator expander, and whereby expander flow temperature is greater than 500 Celsius.

17. The regenerative production system of hydrogen as claimed in claim 14 whereby the non-combustion thermal source producing electricity has a power generator expander, an upstream expander inlet flow has an expander flow temperature to the power generator expander, and whereby expander flow temperature is greater than 600 Celsius.

18. The regenerative production system of hydrogen as claimed in claim 14 whereby the non-combustion thermal source producing electricity has a power generator expander, an upstream expander inlet flow has an expander flow temperature to the power generator expander, and whereby expander flow temperature is greater than 550 Celsius and less than 800 Celsius.

19. The regenerative production system of hydrogen as claimed in claim 18 further consisting of a catalytic methane pyrolysis hydrogen producer, whereby a portion of the upstream expander inlet flow is a preheater to the catalytic methane pyrolysis hydrogen producer.

20. The regenerative production system of hydrogen as claimed in claim 1 further consisting of a compressor as a mechanical vapor compression cycle of an exhaust from the regenerative combustor, a centrifugal water separator downstream of the compressor to enable a non-condensed portion of the exhaust from the regenerative combustor to be reinjected into the regenerative combustor, and a condensed portion of the exhaust from the regenerative combustor for an upstream preheater to the dual reactor electrolyzer.
